(19) United States
(12) Patent Application Publication
(10) Pub. No.: US 2008/0075175 A1
(43) Pub. Date: Mar. 27, 2008

(54) INFORMATION PROCESSING APPARATUS AND METHOD

(75) Inventors: Takanori TAKAHASHI, Kanagawa (JP); Keita Shirane, Kanagawa (JP); Kyohei Koyabu, Kanagawa (JP); Shojiro Shibata, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 11/840,668

(22) Filed: Aug. 17, 2007

(30) Foreign Application Priority Data
Sep. 27, 2006 (JP) 2006-262871

(51) Int. Cl. H04N 7/00

(52) U.S. Cl. 375/240.28; 375/E07.001

(57) ABSTRACT

An information processing apparatus that decodes a plurality of coded streams includes a decoder configured to decode the plurality of coded streams and a control unit configured to control the decoding of the plurality of coded streams so that the start of decoding a subject frame among frames forming the plurality of coded streams is delayed by an amount equal to a delay time, which is the longest pre-processing time among pre-processing times necessary for starting decoding the frames after an instruction to decode the subject frame is given.

### CROSS REFERENCES TO RELATED APPLICATIONS

The present invention contains subject matter related to Japanese Patent Application JP 2006-262871 filed in the Japanese Patent Office on Sep. 27, 2006, the entire contents of which are incorporated herein by reference.

### BACKGROUND OF THE INVENTION

1. Field of the Invention

The present invention relates to information processing apparatuses and methods, and more particularly, to an information processing apparatus and method for allowing the display of a plurality of images to be synchronized with each other more easily.

2. Description of the Related Art

As video compression techniques, Moving Picture Experts Group (MPEG) methods are widely used. When decoding and playing back coded streams, which are compression-coded by an MPEG method, fast playback and reverse playback can be performed in addition to normal playback.

For example, concerning MPEG long groups of pictures (GOPs), one GOP including 15 pictures, by reducing the number of bidirectionally predictive-coded pictures (B-pictures) when GOPs are input into a decoder, fast playback from ×−3 to ×3 (minus (−) represents reverse playback operation) can be implemented (see, for example, Japanese Unexamined Patent Application Publication No. 8-98142).

In an editing apparatus, such as a non-linear editor (NLE), using a hardware accelerator for decoding coded streams, editing can be performed, as shown in FIG. 1, while simultaneously displaying images of a plurality of materials on a display screen of the editing apparatus.

On the display screen, as shown in FIG. 1, a graphical user interface (GUI) includes a timeline area 11 and an image area 12. In the timeline area 11, the playback time and the playback position of video data and audio data, which are materials to be edited, are visually displayed. In the image area 12, images of such materials are displayed.

In the timeline area 11, the playback time of each of video data 21-1 and audio data 22-1 forming material 1 to be edited, which serve as track 1 associated with an image to be displayed in the entire image area 12, is displayed. That is, in the timeline area 11 shown in FIG. 1, the horizontal direction represents the time. The left edges of the rectangles representing the video data 21-1 and the audio data 22-1 indicate the playback start time of the material 1, and the right edges of the rectangles representing the video data 21-1 and the audio data 22-1 indicate the playback end time of the material 1.

Similarly, in the timeline area 11, the playback time of each of video data 21-2 and audio data 22-2 forming material 2 to be edited, which serve as track 2 associated with an image to be displayed in an image area 23 located at the top right position of the image area 12, is displayed. That is, the left edges of the rectangles representing the video data 21-2 and the audio data 22-2 indicate the playback start time of the material 2, and the right edges of the rectangles representing the video data 21-2 and the audio data 22-2 indicate the playback end time of the material 2.

In the timeline area 11, a cursor 24 that designates the positions of images displayed in the image area 12 and the image area 23, i.e., the positions of frames in the video data, is displayed. That is, the frame located at the position of the video data 21-1 designated by the cursor 24 is displayed in the image area 12, and the frame located at the position of the video data 21-2 designated by the cursor 24 is displayed in the image area 23.

When the video data 21-1 and the video data 21-2 are played back in the forward direction, the cursor 24 is shifted to the right side over time, and when the video data 21-1 and the video data 21-2 are played back in the reverse direction, the cursor 24 is shifted to the left side over time. The editor performs editing by displaying images in the image areas 12 and 23 while moving the cursor 24 by operating the editing apparatus.

In this manner, when the editor edits images to be displayed by superimposing an image of the material 2 on an image of the material 1 by operating the editing apparatus, the editing apparatus displays the frames of the material 1 and the material 2 designated by the cursor 24 by synchronizing the frames with each other in accordance with the movement of the cursor 24.

It is now assumed, as shown in FIG. 2A, for example, that the cursor 24 is positioned at the frame A of the video data 21-1 and the frame B of the video data 21-2. A control unit of the editing apparatus, which executes an application program, issues commands to a processor, which controls the decoding of materials by the execution of firmware. In this case, the commands are issued to display the frame of the video data 21-1 and the frame of the video data 21-2 so that decoding is started at a predetermined time.

In FIG. 2A, the horizontal direction represents the time, and the vertical lines designate predetermined times. The time interval T between vertically adjacent solid lines indicates the execution cycle of the commands in the editing apparatus, i.e., the display cycle in which frames are displayed. In FIG. 2A, elements corresponding to those in FIG. 1 are designated with like reference numerals, and an explanation thereof is thus omitted.

At time t1, the control unit issues, on a frame-by-frame basis, commands to display frame A and the subsequent consecutive frames A+1 through A+3 and the frame B and the subsequent consecutive frames B+1 through B+3 to the processor.

In the example shown in FIG. 2A, the control unit issues commands so that the decoding of the frames A through A+3 is started at time t2 to time t5, respectively, and so that the decoding of the frames B through B+3 is started at time t2 to time t5, respectively.

Upon receiving a command from the control unit, the processor controls the decoder so that the decoding of the frame designated by the command is started at a time specified by the command. For example, at time t2, the processor controls the decoder to start decoding the frame A of the material 1 and the frame B of the material 2. The decoding of the frame A and the frame B is finished at time t4 after time t2 by two display cycles.

Accordingly, as shown in FIG. 2B, at time t2, the frame A of the video data 21-1 forming the material 1 is input into a decoder 51-1, and then, at time t4, the frame A is temporarily stored in a frame buffer 52-1 and is supplied to a compositor 53. At time t2, the frame B of the video data 21-2 forming the material 2 is input into a decoder 51-2, and then, at time t4, the frame B is temporarily stored in a frame buffer 52-2 and is supplied to the compositor 53.

Then, the compositor 53 performs composite processing by superimposing the frame B on the frame A and supplies the superimposed image to a resizer 54. The resizer 54 then reduces the size of the superimposed image so that the image becomes equivalent to the size of the display screen of the editing apparatus. Then, the images of the frame A and the frame B are displayed in the display areas 12 and 23, respectively, of the display screen.

If both the frame A and frame B do not need to refer to other frames during decoding, the time necessary from the start of the decoding of the frame A and the frame B to the end of the decoding, i.e., the processing latency, is time 2T from time t2 to time t4. Thus, to synchronize the display of the frame A with that of the frame B, it is sufficient that the frame buffers 52-1 and 52-2 each have a storage capacity for storing one frame of video data.

### SUMMARY OF THE INVENTION

However, if video data to be edited is MPEG-long-GOP video data, the processing latency of the material 1 may be different from that of the material 2 depending on the frame type designated by the cursor 24. It is thus necessary to provide a capacity for a plurality of frames in each of the frame buffers 52-1 and 52-2. Alternatively, in consideration of the processing latency of each material, the time at which decode processing on one type of material is started should be shifted from the time at which decode processing on another type of material is started.

For example, if the frame of the material 1 and the frame of the material 2 designated by the cursor 24 are an intra-coded picture (I-picture), i.e., I2 picture, and a B0 picture, respectively, as shown in FIG. 3, the processing latency of the I2 picture is different from that of the B0 picture. In FIG. 3, the horizontal direction represents the time, and one rectangle represents one frame. The character within a rectangle, such as “I”, “P”, or “B”, represents the picture type of the frame, and the number at the right side of the picture type indicates the order in which the frame, i.e., the picture, is displayed in the GOP.

The arrows A1, A2, B1, and B2 each indicate the range of frames forming one GOP. That is, the arrows A1, A2, B1, and B2 each indicate the frames included in a GOP(M), a GOP(M+1), a GOP(N), and a GOP(N+1), respectively. For example, the GOP(M) includes 15 consecutive pictures from the leftmost B0 picture to the P14 picture.

In the example shown in FIG. 3, the cursor 24 is positioned at the I2 picture of the GOP(M+1) of the material 1 and at the B0 picture of the GOP(N+1) of the material 2.

It is now assumed that the display of the pictures is started from the I2 picture of the GOP(M+1) and the B0 picture of the GOP(N+1) designated by the cursor 24. In this case, the decoding can be started from the I2 picture of the GOP(M+1) since it can be decoded without reference to other pictures.

In contrast, for decoding the B0 picture of the GOP(N+1), it is necessary to refer to the P14 picture one before the B0 picture in the display order and the I2 picture two pictures after the B0 picture in the display order. Additionally, for decoding the P14 picture, P11 picture, P8 picture, and P5 picture of the GOP(N), it is necessary to refer to the P11 picture, P8 picture, P5 picture, and I2 picture, respectively. Accordingly, when starting the display of the pictures from the B0 picture of the GOP(N+1), decoding should be started from the I2 picture of the GOP (N).

In this manner, if the picture type of material 1 and the picture type of material 2 designated by the cursor 24 are different, the numbers of frames that should be decoded before starting displaying images are also different. Accordingly, the processing latency of the material 1 becomes different from the processing latency of the material 2.

Thus, if the processing latency of the material 1 and the processing latency of the material 2 are different, as shown in FIG. 4A, to simultaneously start processing on the material 1 and the material 2 after decoding, as shown in FIG. 4B, a storage capacity storing a plurality of frames is necessary at least in one of the frame buffers 52-1 and 52-2 in order to absorb the difference in the processing latency. In FIGS. 4A and 4B, elements corresponding to those in FIGS. 2A and 2B are designated with like reference numerals, and an explanation thereof is thus omitted.

In the example shown in FIG. 4A, at time t1, the control unit issues, on a frame-by-frame basis, commands to display the frame A through the frame A+3 and commands to display the frame B through the frame B+3 to the processor.

Upon receiving the commands from the control unit, the processor controls the decoders to start decoding the frames specified by the commands at times designated by the commands. For example, at time t2, the processor controls the decoders 51-1 and 51-2 to start decoding the frame A of the material 1 and the frame B of the material 2.

The decoding of the frame A is finished at time t4 two cycles after time t2, and the decoded frame A is supplied to and stored in the frame buffer 52-1. Then, after being decoded, the frame A+1, the frame A+2, and the frame A+3 are sequentially supplied to and stored in the frame buffer 52-1 in every display cycle.

The decoding of the frame B is finished at time t6 four cycles after time t2, and the decoded frame B is supplied to and stored in the frame buffer 52-2. Then, after being decoded, the frame B+1, the frame B+2, and the frame B+3 are sequentially supplied to and stored in the frame buffer 52-1 in every display cycle.

In this manner, if the picture type of frame A is different from that of frame B, as shown in FIG. 4B, the following situation is encountered since the processing latency is different between the frame A and the frame B. When the frame B is supplied to the frame buffer 52-2, the frame A and the frame A+1 are already stored in the frame buffer 52-1, and when the frame B is supplied to the frame buffer 52-2, the frame A+2 is supplied to the frame buffer 52-1.

After the frame B is stored in the frame buffer 52-2, the frame A and the frame B are supplied to the compositor 53 from the frame buffers 52-1 and 52-2 and are subjected to composite processing.

Accordingly, in order to synchronize the display of the frame A with the display of the frame B, the frame buffer 52-1 requires a storage capacity for storing three frames of video data. It is also necessary to perform control such that the frame A and the frame B are simultaneously supplied to the compositor 53.

As described above, when performing editing while displaying images of a plurality of materials at the same time, to absorb the difference in the processing latency between the materials, it is necessary to reserve a storage capacity in a buffer and to perform complicated control for synchronizing the display of a frame of one material with that of another material. That is, it is necessary to control the start time of each processing for the different materials by considering the processing latency of each material.

It is thus desirable to allow the display of a plurality of images to be synchronized with each other more easily.

According to an embodiment of the present invention, there is provided an information processing apparatus that decodes a plurality of coded streams. The information processing apparatus includes decoding means for decoding the plurality of coded streams and control means for controlling the decoding of the plurality of coded streams so that the start of decoding a subject frame among frames forming the plurality of coded streams is delayed by an amount equal to a delay time, which is the longest pre-processing time among pre-processing times necessary for starting decoding the frames after an instruction to decode the subject frame is given.

The information processing apparatus may further include storage means for storing video signals obtained as a result of performing decoding by the decoding means.

The control means may delay the start of decoding the subject frame by an amount equal to the delay time which is determined by a bit rate of the plurality of coded streams.

The decoding means may include a first decoder that decodes a first coded stream and a second decoder that decodes a second coded stream. The control means may delay the start of decoding a subject frame among frames forming the first coded stream and the second coded stream by an amount equal to the delay time which is determined by a higher bit rate of bit rates of the first coded stream and the second coded stream.

The plurality of coded streams may be streams in conformity with MPEG standards. The delay time may be determined on the basis of a time necessary for inputting the plurality of coded streams into the decoding means and a time necessary for decoding another frame which is decoded before the subject frame.

The delay time may be an integral multiple of a length of a display cycle of the frames forming the plurality of coded stream. The decoding means may count a time before the decoding of the subject frame is started by decrementing the delay value by every duration equal to the length of the display cycle on the basis of a clock signal synchronizing with the display cycle.

According to another embodiment of the present invention, there is provided an information processing method for decoding a plurality of coded streams. The information processing method includes the steps of controlling the decoding of the plurality of coded streams so that the start of decoding a subject frame among frames forming the plurality of coded streams is delayed by an amount equal to a delay time, which is the longest pre-processing time among pre-processing times necessary for starting decoding the frames after an instruction to decode the subject frame is given, and decoding the plurality of coded streams.

According to an embodiment of the present invention, in information processing for decoding a plurality of coded streams, the decoding of the plurality of coded streams is controlled so that the start of decoding a subject frame of frames forming the plurality of coded streams is delayed by an amount equal to a delay time, which is the longest pre-processing time among pre-processing times necessary for starting decoding the subject frame after an instruction to decode the subject frame is given. Then, the plurality of coded streams are decoded.

According to an embodiment of the present invention, coded streams can be decoded. In particular, the display of images can be synchronized with each other more easily.

### BRIEF DESCRIPTION OF THE DRAWINGS

FIG. 1 illustrates an example of a GUI displayed on an editing apparatus when images are edited;

FIGS. 2A and 2B illustrate processing latencies of coded streams in a known editing method;

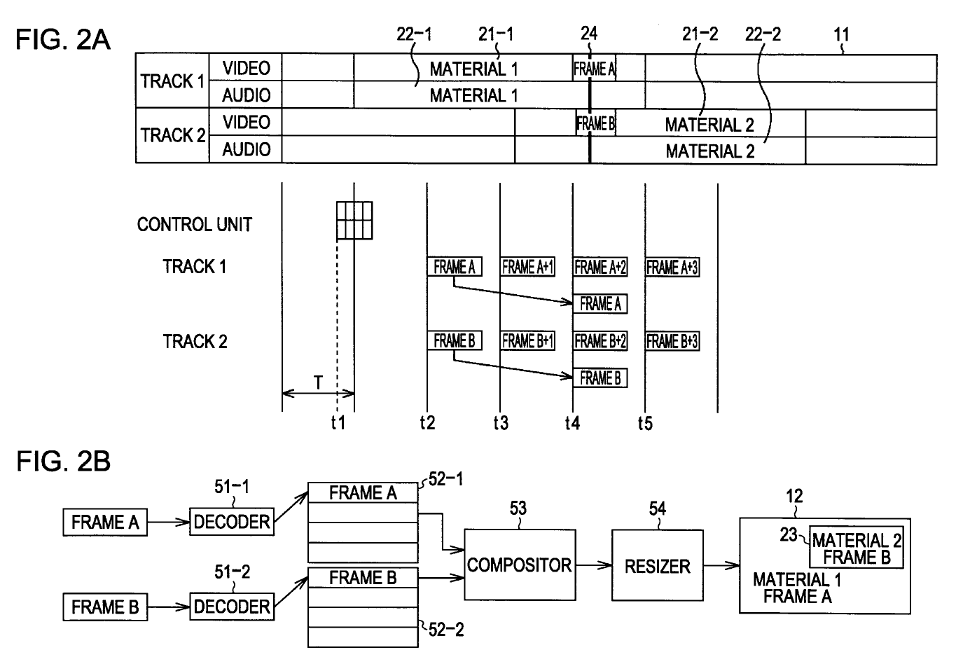

FIG. 3 illustrates the difference in the processing latency between coded streams due to the difference in the picture types;

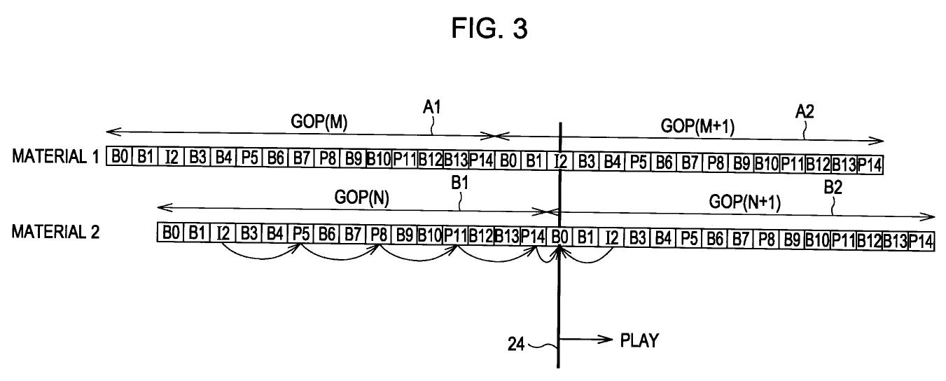

FIGS. 4A and 4B illustrate processing latencies of coded streams in a known editing method;

FIG. 5 is a block diagram illustrating the hardware configuration of an editing apparatus according to an embodiment of the present invention;

FIG. 6 is a block diagram illustrating the functional configuration of an editing apparatus;

FIG. 7 is a block diagram illustrating the detailed configuration of a control unit;

FIG. 8 is a block diagram illustrating the configuration of a decoder;

FIGS. 9A and 9B illustrate a processing latency of coded streams;

FIGS. 10A through 10C illustrate a processing latency of coded streams;

FIGS. 11A through 11D illustrate an overview of processing performed by a decoder;

FIG. 12 illustrates an overview of processing performed by an editing apparatus;

FIG. 13 is a flowchart illustrating display control processing;

FIG. 14 is a flowchart illustrating execution control processing;

FIG. 15 is a flowchart illustrating decode command generating processing;

FIGS. 16A and 16B illustrate a GOP ID queue;

FIG. 17 illustrates a delay table;

FIG. 18 is a flowchart illustrating decode processing;

FIG. 19 illustrates a decode command queue;

FIGS. 20A through 20C illustrate processing latencies of coded streams;

FIG. 21 is a flowchart illustrating display control processing; and

FIG. 22 is a block diagram illustrating the configuration of a personal computer.

### DESCRIPTION OF THE PREFERRED EMBODIMENTS

An embodiment of the present invention is described below with reference to the accompanying drawings.

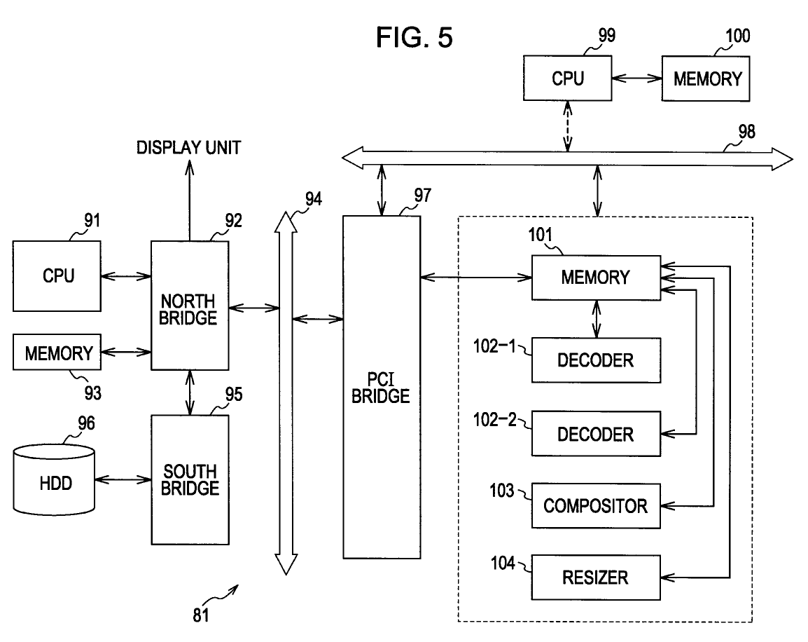

FIG. 5 is a block diagram illustrating the hardware configuration of an editing apparatus 81 according to an embodiment of the present invention.

A central processing unit (CPU) 91, which is connected to a north bridge 92, performs control of readout of data stored in a hard disk drive (HDD) 96 and generates and outputs commands to start, change, or finish decoding scheduling, decoding, and display output performed by a CPU 99. The north bridge 92, which is connected to a peripheral component interconnect/interface (PCI) 94, under the control of the CPU 91, receives data stored in the HDD 96 via a south bridge 95 and supplies the received data to a memory 101 via the PCI bus 94 and a PCI bridge 97. The north bridge 92 is also connected to a memory 93 and supplies and receives data necessary for the CPU 91 to perform processing.

The memory 93 is a fast access storage memory, such as a double-data-rate (DDR) storage memory, that can store data necessary for the CPU 91 to perform processing. The south bridge 95 controls the writing and reading of the data stored in the HDD 96. In the HDD 96, coded streams, which are coded stream data compressed by MPEG standards, are stored.

Under the control of the CPU 91, the PCI bridge 97 can supply coded streams read from the HDD 96 to the memory 101 and stores them in the memory 101. The PCI bridge 97 can also read non-compressed video signals generated by decoding coded streams from the memory 101 and supplies the non-compressed video signals to the memory 93 via the PCI bus 94 and the north bridge 92. The PCI bridge 97 controls the supply and reception of control signals corresponding to commands or results via the PCI bus 94 or a control bus 98.

The CPU 99 receives commands from the CPU 91 via the control bus 98, the PCI bridge 97, the PCI bus 94, and the north bridge 92, and controls processing executed by the PCI bridge 97, decoders 102-1 and 102-2, a compositor 103, and a resizer 104 in accordance with the received commands. A memory 100 stores data necessary for the CPU 99 to perform processing.

Under the control of the CPU 99, the decoders 102-1 and 102-2 decode coded streams supplied from the memory 101 into non-compressed serial digital interface (SDI) data and supply the SDI data to the memory 101 and store them therein. The decoders 102-1 and 102-2 may be provided as an independent device, separately from the editing apparatus 81. The decoders 102-1 and 102-2 are simply referred to as the “decoder 102” unless it is necessary to distinguish them.

The compositor 103 obtains a plurality of video signals stored in the memory 101 and performs composite processing on the video signals so that a plurality of images associated with the video signals can be displayed by being superimposed on each other. The compositor 103 also supplies the composite video signal to the memory 101 and stores it therein.

The resizer 104 obtains the composite video signal stored in the memory 101 and performs reduction processing on the video signal so that the size of the image associated with the video signal becomes equal to the size of the display screen of a display device (not shown) connected to the editing apparatus 81. The resizer 104 then supplies the video signal subjected to the reduction processing to the memory 101 and stores it therein.

The editing apparatus 81 shown in FIG. 5 may be formed as a single device or a plurality of devices. The editing apparatus 81 may be configured, for example, in the following manner. The CPU 91, the north bridge 92, the memory 93, the south bridge 95, and the HDD 96 shown in FIG. 5 may be formed into part of a personal computer, and the functions of the PCI bus 94, the PCI bridge 97, the control bus 98, the CPU 99, the memory 100, the memory 101, the decoders 102-1 and 102-2, the compositor 103, and the resizer 104 may be provided for an expansion card, such as a PCI card or a PCI-Express card, or an expansion board. Then, the expansion card or the expansion board may be inserted into the personal computer. The editing apparatus 81 configured as described above may be divided into a plurality of devices.

The operation of the editing apparatus 81 is as follows.

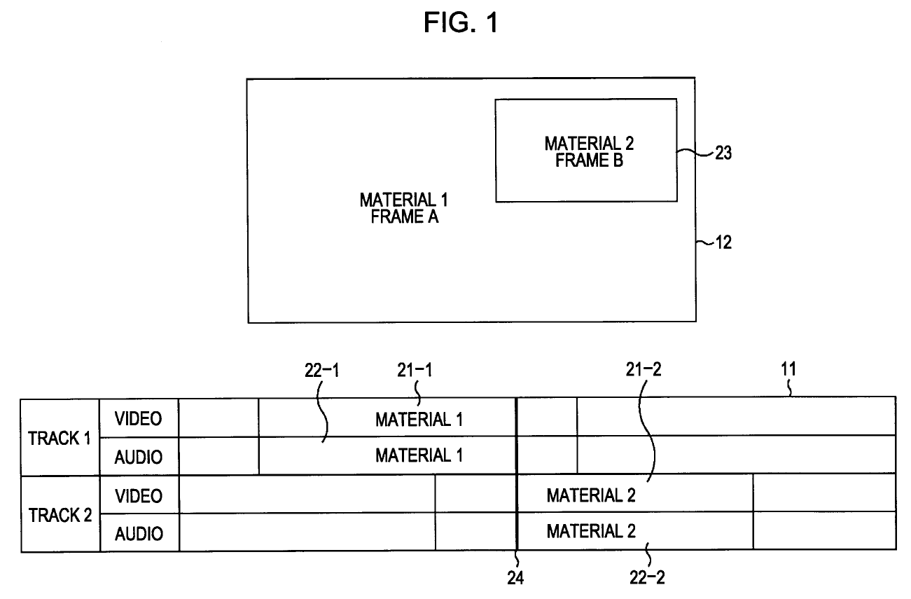

In the HDD 96, MPEG-long-GOP coded streams are stored. In the HDD 96, for example, coded stream A and coded stream B for displaying an image in the image area 12 and an image in the image area 23, respectively, of the display screen shown in FIG. 1 during editing are stored.

The CPU 91 controls the south bridge 95 via the north bridge 92 to read the coded stream A and the coded stream B from the HDD 96 in response to the input of an operation performed by a user with an operation input unit (not shown), and to supply the read coded streams A and B to the memory 101 via the north bridge 92, the PCI bus 94, and the PCI bridge 97 and store them in the memory 101. The CPU 91 also supplies information concerning the playback speed (including the playback direction) and display commands to execute processing necessary for displaying images to the CPU 99 via the north bridge 92, the PCI bus 94, the PCI bridge 97, and the control bus 98.

The CPU 99 conducts scheduling for decoding and displaying the coded stream A and the coded stream B transferred to the memory 101 on the basis of the display commands supplied from the CPU 91. More specifically, the CPU 99 selects the type of decoder 102 used for decoding, and determines input timing at which the coded streams A and B are input into the decoder 102, the decoding timing of each frame, setting of the bank positions of reference frames, and allocation of the bank memories during decoding.

The CPU 99 then controls the memory 101 to supply the coded stream A and the coded stream B stored in the memory 101 to the decoders 102-1 and 102-2, respectively, on the basis of the schedules. The CPU 99 then controls the decoders 102-1 and 102-2 to decode the coded streams A and B, respectively, and to supply the non-compressed video signals A and B, respectively, to the memory 101.

The CPU 99 controls the compositor 103 to perform composite processing on the video signals A and B stored in the memory 101 and to supply the resulting video signal to the memory 101 and store it therein. The CPU 99 then controls the resizer 104 to perform reduction processing on the video signal stored in the memory 101 and to supply the resulting video signal to the memory 101.

The CPU 91 controls the north bridge 92 to read out the video signal subjected to the reduction processing stored in the memory 101 via the PCI bus 94 and the PCI bridge 97, and to supply the video signal to the memory 93 and store it therein. The CPU 91 then supplies the video signal stored in the memory 93 to a display device (not shown) via the north bridge 92 and controls the display device to display the GUI image shown in FIG. 1.

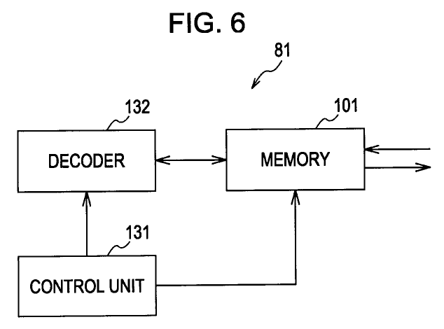

FIG. 6 is a block diagram illustrating an example of the functional configuration of the editing apparatus 81 shown in FIG. 5. In FIG. 6, elements corresponding to those in FIG. 5 are designated with like reference numerals, and an explanation thereof is thus omitted.

The editing apparatus 81 includes a control unit 131, a decoder 132, and the memory 101.

The control unit 131 is formed of the CPU 91 and the CPU 99 shown in FIG. 5, and controls the elements forming the editing apparatus 81. The control unit 131 controls the memory 101 to supply the coded streams A and B read from the HDD 96 and supplied to the memory 101 to the decoder 132 and controls the decoder 132 to decode the coded streams A and B supplied from the memory 101.

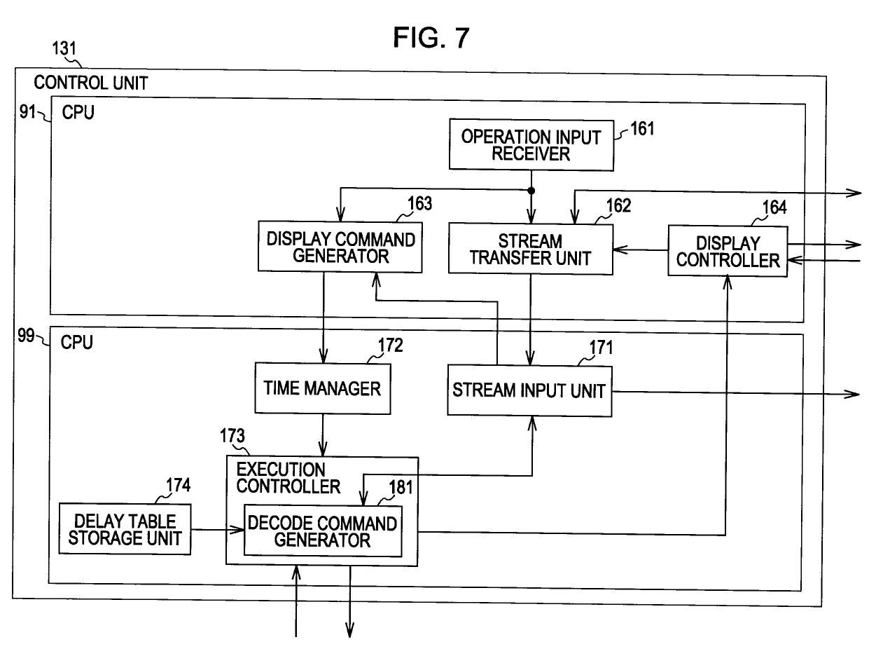

The decoder 132, which is formed of the decoders 102-1 and 102-2, decodes the coded streams A and B supplied from the memory 101 and supplies the decoded streams A and B to the memory 101. Although in this embodiment the number of decoders provided for the editing apparatus 81 is two, one decoder or three or more decoders may be provided. The detailed configuration of the control unit 131 is shown in FIG. 7.

The control unit 131 includes the CPU 91 and the CPU 99. The CPU 91 includes an operation input receiver 161, a stream transfer unit 162, a display command generator 163, and a display controller 164. The CPU 99 includes a stream input unit 171, a time manager 172, an execution controller 173, and a delay table storage unit 174.

The operation input receiver 161, the stream transfer unit 162, the display command generator 163, and the display controller 164 are each implemented by executing an image editing application program by the CPU 91. The stream input unit 171, the time manager 172, the execution controller 173, and the delay table storage unit 174 are each implemented by executing firmware for controlling various types of processing, such as decoding, by the CPU 99.

The operation input receiver 161 receives the input of an operation performed by the user and obtains information concerning the operation, such as a coded stream to be edited, the bit rate ID indicating the bit rate, and more specifically, the amount of data per second when the coded stream is input into the decoder 102, and the position of a frame to be displayed first. The operation input receiver 161 then supplies the obtained information to the stream transfer unit 162 and the display command generator 163.

The stream transfer unit 162 controls the north bridge 92 to transfer the coded stream to the memory 101 in units of GOPs on the basis of the information supplied from the operation input receiver 161. Upon completion of the transfer of the coded stream to the memory 101, the stream transfer unit 162 sends a transfer completion report to the stream input unit 171 of the CPU 99 and also supplies GOP information, such as the GOP IDs identifying the transferred GOPs, the GOP sizes, the addresses of the memory 101 at which the GOPs are stored, picture information concerning the frames, i.e., the pictures, forming the GOPs, to the stream input unit 171. The picture information includes information concerning the picture types, picture header, and picture sizes in the GOP.

The display command generator 163 generates, on the basis of the information supplied from the operation input receiver 161, display commands to execute processing necessary for displaying images associated with the coded streams A and B to be edited, and supplies the generated display commands to the time manager 172. The display command is a command to execute processing for one frame of the coded stream, and the display command generator 163 generates the same number of display commands as the number of frames to be displayed. The display command includes the GOP ID identifying the GOP containing the subject frame, the frame ID identifying the frame, the start time at which the execution of the display command is started, and the bit rate ID of the coded stream.

Upon receiving a display-command processing completion report from the execution controller 173 of the CPU 99, the display controller 164 controls the north bridge 92 to temporarily store, in the memory 93, a video signal for displaying decoded and superimposed frames stored in the memory 101, and then controls the memory 93 to supply the video signal to the display device via the north bridge 92 and controls the display device to display the image associated with the video signal.

In response to a request to transfer a coded stream from a decode command generator 181 of the execution controller 173, the stream input unit 171 controls the memory 101 to input one GOP of the coded stream stored in the memory 101 into the decoder 102.

The time manager 172 analyzes the display commands supplied from the display command generator 163 and performs scheduling for the times at which operations specified by the display commands are performed. For example, the time manager 172 refers to the start times indicated in the display commands supplied from the display command generator 163 and then supplies display commands that have reached the execution time to the execution controller 173.

Upon receiving the display commands from the time manager 172, the execution controller 173 controls the decoder 102, the compositor 103, and the resizer 104 to perform decoding, composite processing, and reduction processing, respectively, on the coded streams to be edited.

The decode command generator 181 of the execution controller 173 obtains from a delay table stored in the delay table storage unit 174 a delay value indicating the delay time for delaying the start of the decoding on the basis of the bit rate ID contained in the display command supplied from the time manager 172.

The delay value has been determined for a coded stream having a predetermined bit rate, i.e., for each bit rate, from the time necessary for transferring the GOP containing a subject frame and the GOP including reference frames for decoding the subject frame from the memory 101 to the decoder 102 and from the pre-processing time necessary for starting decoding the subject frame.

That is, the delay time is the longest pre-processing time for performing pre-processing before starting decoding the subject frame, such as transferring GOPs and decoding reference frames after an instruction to decode the subject frame has been given. In other words, the longest pre-processing time is used as the delay time represented by the delay value.

Accordingly, no matter which frame, i.e., which picture, in a predetermined GOP is displayed first, the start time of the decoding of the subject frame is delayed by an amount equal to the delay time represented by the delay value. With this arrangement, regardless of the picture type of the subject frame and the position of the subject frame in the GOP, the decoding of the coded streams A and B that are displayed by being superimposed on each other can be finished at the same time.

After obtaining the delay value from the delay table stored in the delay table storage unit 174, the decode command generator 181 generates a decode command to decode the frame specified by the display command and supplies the generated decode command to the decoder 102. The decode command includes the frame ID identifying the frame to be decoded, the GOP ID identifying the GOP containing the subject frame, the obtained delay value, and information concerning reference frames for decoding the subject frame.

As discussed above, the delay table storage unit 174 stores a delay table including delay values indicating the delay times for bit rates of the coded streams.

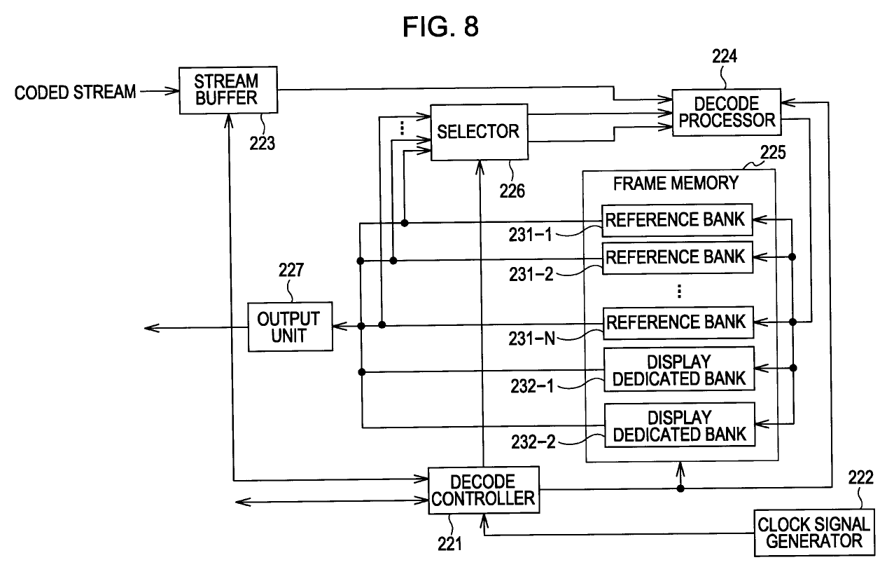

FIG. 8 is a block diagram illustrating an example of the detailed configuration of the decoder 102 shown in FIG. 5.

In response to a decode command supplied from the decode command generator 181, a decode controller 221 controls the elements forming the decoder 102 to execute predetermined operations in synchronization with a clock signal supplied from a clock signal generator 222. The decode controller 221 also obtains, for every frame, the head address at which the frame is stored, data size, picture header information, and Q matrix, from the coded stream stored in a stream buffer 223.

The clock signal generator 222 generates a clock signal and supplies it to the decode controller 221. The clock signal generator 222 generates, for example, a clock signal having a cycle one-fourth the display cycle in which images are displayed in the image areas 12 and 23, i.e., a clock signal having a frequency four times as high as the display cycle.

The stream buffer 223 stores coded streams supplied from the memory 101, and supplies the coded streams on a frame-by-frame basis to a decode processor 224 under the control of the decode controller 221. The decode processor 224 refers to, if necessary, a baseband video signal supplied from a selector 226, i.e., reference frames for decoding a P-picture or a B-picture, and decodes the coded streams supplied from the stream buffer 223 on a frame-by-frame basis. The decode processor 224 supplies the non-compressed video signal obtained as a result of decoding to a frame memory 225 on a frame-by-frame basis.

The frame memory 225 stores the coded streams supplied from the decode processor 224 and supplies the stored coded streams to the selector 226 or an output unit 227. The frame memory 225 includes reference banks 231-1 through 231-N for storing I-pictures and P-pictures used as reference frames for the other pictures, and display dedicated banks 232-1 and 232-2 dedicated for displaying B-pictures.

The reference banks 231-1 through 231-N each store a video signal for one frame, which serves as a reference frame, supplied from the decode processor 224. The display dedicated banks 232-1 and 232-2 each store a video signal associated with a B-picture frame.

The reference banks 231-1 through 231-N are hereinafter simply referred to as the “reference bank 231” unless they have to be distinguished from each other. The display dedicated banks 232-1 and 232-2 are hereinafter simply referred to as the “display dedicated bank 232” unless they have to be distinguished from each other.

The selector 226 supplies, under the control of the decode controller 221, the video signal associated with the frame stored in one of the reference banks 231-1 through 231-N of the frame memory 225 to the decode processor 224. The output unit 227 supplies, under the control of the decode controller 221, the video signal for one frame stored in the reference bank 231 or the display dedicated bank 232 of the frame memory 225 to the memory 101 and stores the video signal therein.

A description is now given of an overview of processing executed when the editing apparatus 81 displays images in the image areas 12 and 23 on the GUI screen shown in FIG. 1 by using the coded streams A and B while displaying the GUI screen on a display device connected to the editing apparatus 81. In the following description, it is assumed that the bit rates of the coded streams A and B are the same.

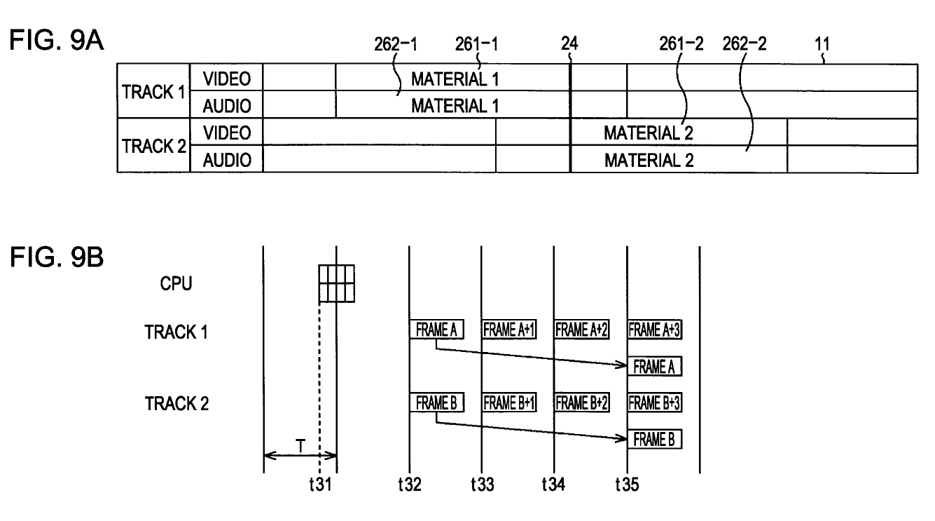

It is now assumed, for example, that, as shown in FIG. 9A, in the timeline area 11, the playback time of each of a coded stream 261-1 as video data forming material 1 to be edited and audio data 262-1 forming material 1, which serve as track 1, is displayed. Also, the playback time of each of a coded stream 261-2 as video data forming material 2 to be edited and audio data 262-2 forming material 2, which serve as track 2, is displayed.

In this case, in response to an instruction to play back the materials 1 and 2 from the user by operating the editing apparatus 81, the editing apparatus 81 performs decoding, composite processing, reduction processing, and playback processing, on the materials 1 and 2 so that the playback of the coded streams 261-1 and 261-2 is started by the positions of the frames designated by the cursor 24.

That is, as shown in FIG. 9B, at time t31, the CPU 91 issues display commands for the frames forming the coded streams 261-1 and 261-2 and supplies the generated display commands to the CPU 99. In FIG. 9B, the horizontal direction represents the time, and the vertical lines designate predetermined times. The time interval T between vertically adjacent solid lines indicates the execution cycle of the commands in the editing apparatus 81, i.e., the display cycle in which frames are displayed.

In the following description, the coded streams 261-1 and 261-2 are simply referred to as the “coded stream 261” unless they have to be distinguished from each other.

In response to the display commands from the CPU 91, the CPU 99 sequentially generates decode commands for the received display commands starting from the display command that has reached the execution time, and supplies the generated decode commands to the decoder 102 to control the decoder 102 to start decoding. In the example shown in FIG. 9B, from time t32, the decoding of the coded streams 261-1 and 261-2 is started on a frame-by-frame basis in every display cycle.

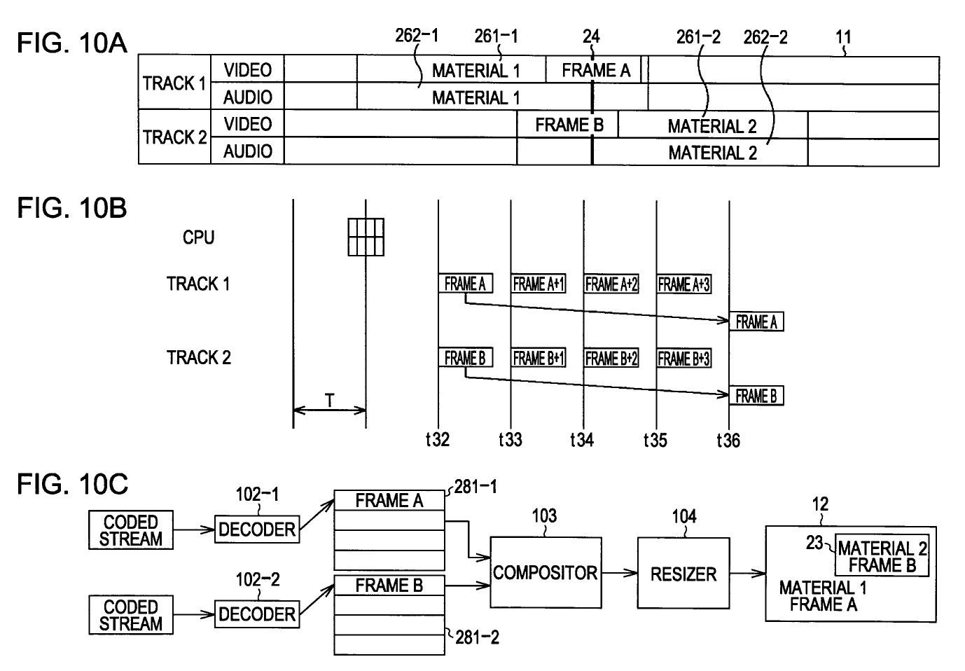

It is now assumed, for example, that as shown in FIG. 10A, the cursor 24 is positioned at the frame A of the coded stream 261-1 and the frame B of the coded stream 261-2. In this case, at time t32, as shown in FIG. 10B, the CPU 99 issues decode commands associated with the display commands of the frames A and B that have reached the execution times by considering the delay values indicated in the display commands, and supplies the issued decode commands to the decoders 102-1 and 102-2.

Then, at time t33 to time t35, the CPU 99 sequentially issues decode commands associated with the display commands of the consecutive frames A+1 through A+3 subsequent to the frame A of the coded stream 261-1, and also sequentially issues decode commands associated with the display commands of the consecutive frames B+1 through B+3 subsequent to the frame B of the coded stream 261-2, and supplies the issued decode commands to the decoders 102-1 and 102-2.

Upon receiving the decode commands from the CPU 99, the decoder 102 delays the start of the decoding by an amount equal to the delay time represented by the delay value contained in the decode commands, and then executes the decode commands to decode the coded stream 261. In the example shown in FIG. 10B, the decoding of the frame A and the frame B is finished at time t36. Accordingly, if the display cycle is T, the processing latency of the materials 1 and 2 is 4T.

In this manner, by issuing decode commands containing a delay value and by delaying the start time of the frame decoding by the time represented by the delay value, the processing latency of the material 1 and that of the material 2 can become the same duration regardless of the picture types and the positions of frames A and B in the GOPs.

That is, the longest pre-processing time before starting to decode a frame specified by the first decode command supplied to the decoder 102 after an instruction to decode the frame to be displayed first has been given is set to be the delay time, and then, the decoder 102 delays starting to decode the first frame by an amount equal to the delay time. With this arrangement, regardless of the time necessary for transferring GOPs or the pre-processing time necessary for decoding reference frames for the first frame, the decoding of the frame specified by the decode command can reliably be started at the time after the lapse of the delay time after an instruction to decode the frame has been given.

More specifically, the pre-processing time lasts from the time at which the execution of the display command by the CPU 99 is started to the time at which the decoding of the frame specified by the decode command associated with the display command is started. However, the period from the time at which the execution of the display command is started to the time at which the decoder 102 receives the decode command is very short. Accordingly, the time at which the decoder 102 receives the decode command can be considered as the start time of the pre-processing time.

In this manner, the CPU 99 controls the decoding of coded streams so that, when the display-command execution time has been reached, only pre-processing, such as transferring of GOPs and decoding of reference frames, is immediately started and the decoding of the first frame to be displayed is started after the lapse of the delay time.

Thus, as shown in FIG. 10C, when the GOP including the frame A of the coded stream 261-1 and the GOP including the frame B of the coded stream 261-2 are supplied to the decoders 102-1 and 102-2, respectively, the decoders 102-1 and 102-2 decode the frames A and B by delaying starting to decode the frames A and B by an amount equal to the delay time represented by the delay value contained in the decode commands. The decoders 102-1 and 102-2 then supply the decoded frames A and B to ring-buffer-structured frame buffers 281-1 and 281-2, respectively, provided in a predetermined area of the memory 101.

In this case, by the issuance of decode commands containing a delay value, the processing latency of the material 1 and that of the material 2 can become the same duration. Thus, it is sufficient that the frame buffers 281-1 and 281-2 each have a storage capacity for storing data equivalent to only one frame.

Subsequently, the frames A and B stored in the frame buffers 281-1 and 281-2, respectively, are supplied to the compositor 103 and are subjected to composite processing. The composite frames A and B are then subjected to reduction processing in the resizer 104, and are displayed in the image areas 12 and 23 of the display device.

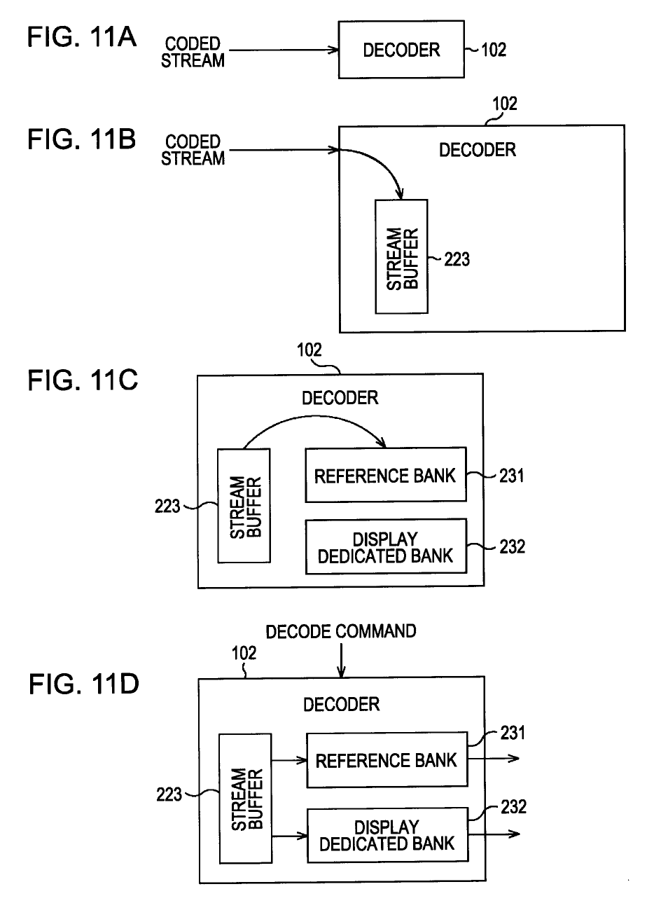

In the decoder 102, when the coded stream 261 is input into the decoder 102, as shown in FIG. 11A, it is supplied to and stored in the stream buffer 223 of the decoder 102, as shown in FIG. 11B.

When the coded stream 261 is stored in the stream buffer 223, as shown in FIG. 11C, predetermined some of the I-pictures and P-pictures forming the coded stream 261 are decoded simultaneously with the input of the coded stream 261, and the decoded pictures are stored in the reference bank 231. In the following description, among the frames forming a coded stream, frames that are decoded simultaneously with the input of the coded stream are also referred to as “anchor frames”.

When a decode command is supplied from the CPU 99 to the decoder 102, as shown in FIG. 11D, the decoder 102 delays starting to decode the frame specified by the decode command by an amount equal to the delay time represented by the delay value contained in the decode command, and then, decodes the subject frame. The decoded frame is then temporarily stored in the reference bank 231 or the display dedicated bank 232 and is supplied to the memory 101.

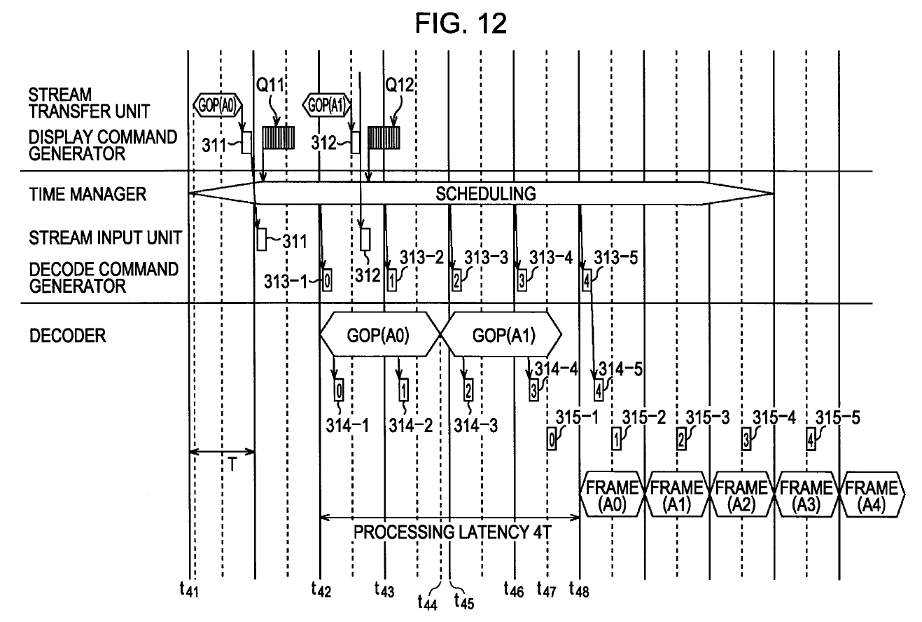

More specifically, in response to an instruction to play back an image of a material to be edited, as shown in FIG. 12, at time t41, the stream transfer unit 162 of the CPU 91 starts transferring the GOP(A0) containing a frame to be displayed first (also including the previous GOP if it is necessary for decoding the first frame) to the memory 101.

In FIG. 12, the horizontal direction represents the time, and the vertical lines designate predetermined times. The time interval T between vertically adjacent solid lines indicates the execution cycle of the commands in the editing apparatus 81, i.e., the display cycle in which frames are displayed.

Upon completion of the transfer of the GOP(A0) to the stream transfer unit 162, the stream transfer unit 162 sends GOP information concerning the GOP(A0), together with a transfer completion report 311, to the stream input unit 171 of the CPU 99. The display command generator 163 issues a display command for each of the frames indicated by the arrow Q11 and sends the display commands to the time manager 172 of the CPU 99. The display commands indicated by the arrow Q11 form a display command set including the display commands for the individual frames of the GOP (A0).

Similarly, the stream transfer unit 162 of the CPU 91 starts transferring the GOP(A1) after the GOP(A0), and upon completion of the transfer of the GOP(A1) to the memory 101, the stream transfer unit 162 sends GOP information concerning the GOP(A1), together with a transfer completion report 312, to the stream input unit 171 of the CPU 99. The display command generator 163 issues a display command for each of the frames, i.e., display frames indicated by the arrow Q12, and sends them to the time manager 172 of the CPU 99.

Meanwhile, in the CPU 99, the stream input unit 171 of the CPU 99 receives the transfer completion reports 311 and 312 from the stream transfer unit 162. Then, in response to a request from the decode command generator 181, at time t42, the stream input unit 171 starts transferring the GOP(A0) to the decoder 102, and upon completing the transfer of the GOP(A0), at time t44, the stream input unit 171 starts transferring the GOP(A1) to the decoder 102.

The time manager 172 receives the display commands indicated by the arrows Q11 and Q12 from the display command generator 163, and performs scheduling for the execution of the received display commands. More specifically, at time t42, the time manager 172 supplies a display command 313-1 that has reached the execution time to the decode command generator 181, and then, subsequently supplies display commands 313-2 through 313-5 in every cycle to the decode command generator 181. That is, the time manager 172 supplies the display commands 313-2 through 313-5 to the decode command generator 181 at time t43, time t45, time t46, and time t48, respectively.

Upon receiving the display commands 313-1 through 313-5 from the time manager 172, the decode command generator 181 issues decode commands 314-1 through 314-5 associated with the display commands 313-1 through 313-5, respectively, by taking the delay value into consideration, and sends the decode commands 314-1 through 314-5 to the decoder 102. The display commands 313-1 through 313-5 are hereinafter simply referred to as the “display command 313” unless they have to be distinguished from each other. The decode commands 314-1 through 314-5 are hereinafter simply referred to as the “decode command 314” unless they have to be distinguished from each other.

Upon receiving the decode command 314 from the decode command generator 181, the decoder 102 waits by an amount equal to the delay time represented by the delay value and sequentially starts decoding the frames specified by the decode command 314.

Upon completion of the decoding of the frames, the decoder 102 sends decode completion reports 315-1 through 315-5 to the execution controller 173 of the CPU 99 in the order in which the frames have been decoded. In the example shown in FIG. 12, at time t47, the decode completion report 315-1 is sent to the execution controller 173. Then, decode completion reports 315-2 through 315-5 are sequentially sent to the execution controller 173 in every cycle. The decode completion reports 315-1 through 315-5 are hereinafter simply referred to as the “decode completion report 315”.

After sending the decode completion report 315, the decoder 102 starts transferring a decoded frame that has reached the display time to the memory 101. In the example shown in FIG. 12, at time t48, the transfer of the frame A0 of the GOP(A0) specified by the display command 313-1 is started, and after the frame A0, the frames Al through A4 are sequentially transferred in every display cycle.

In the example shown in FIG. 12, the processing latency of each frame is 4 display cycles, i.e., 4T. The CPU 99 performs decoding scheduling, e.g., for a delay value, so that the processing latency becomes 4T.

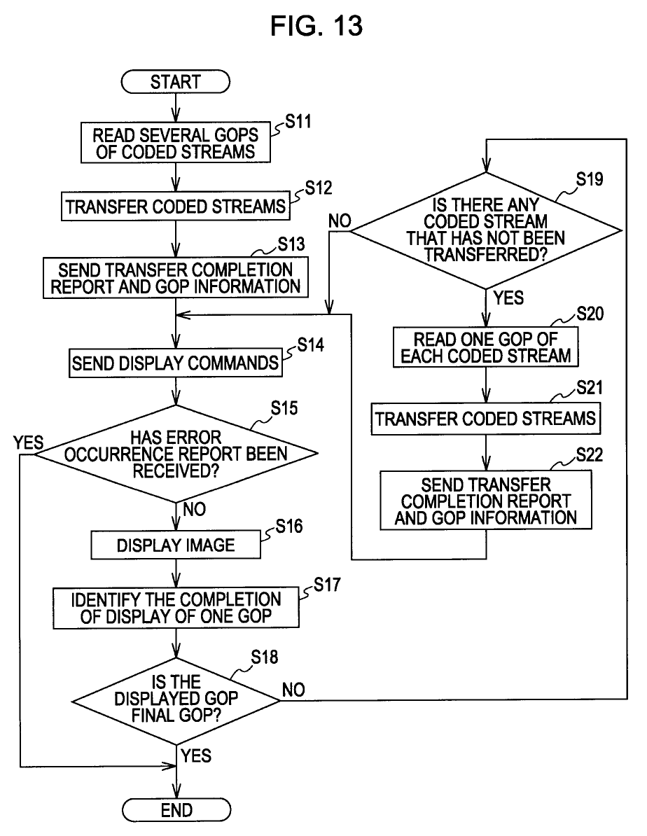

Display control processing performed by the CPU 91 is described below with reference to the flowchart in FIG. 13. This display control processing is started when the user operates the editing apparatus 81 to give an instruction to play back images displayed in the image areas 12 and 23 shown in FIG. 1.

In step S11, the stream transfer unit 162 reads a plurality of GOPs of coded streams stored in the HDD 96. That is, the operation input receiver 161 receives the input of an operation performed by the user and obtains information concerning the operation, such as the bit rate IDs of the coded streams A and B associated with the images to be displayed in the image areas 12 and 23, respectively, and information concerning the positions of the frames at which the display of the coded streams A and B is started. The operation input receiver 161 then supplies the obtained information to the stream transfer unit 162 and the display command generator 163.

On the basis of the information received from the operation input receiver 161, the stream transfer unit 162 then controls the north bridge 92 to read out the GOP including the frame at which the display of the coded stream A is started and the subsequent GOPs from the HDD 96 via the south bridge 95, and also to read out the GOP including the frame at which the display of the coded stream B is started and the subsequent GOPs from the HDD 96 via the south bridge 95.

The stream transfer unit 162 then sends a command to add a GOP ID identifying the corresponding GOP to the coded stream to the stream input unit 171. This command includes information concerning the GOP ID and the position at which the GOP is stored in the memory 101.

Upon receiving the command from the stream transfer unit 162, the stream input unit 171 controls the north bridge 92 to add the GOP ID identifying the corresponding GOP to the GOP of the coded stream A or B. It should be noted that the GOP ID is not inserted into the MPEG header, but into the head of the video data contained in the GOP.

The north bridge 92 reads out the GOPs of the coded stream from the HDD 96 via the south bridge 95 under the control of the stream transfer unit 162, and then adds the GOP IDs to the read GOPs under the control of the stream input unit 171. In this manner, by the addition of the GOP ID to the head of each GOP, the decoder 102 can refer to the GOP ID of each GOP input into the stream buffer 223 of the decoder 102 to specify the corresponding GOP.

In step S12, the stream transfer unit 162 controls the north bridge 92 to transfer the read coded streams to the memory 101. The north bridge 92 supplies the coded streams in units of GOPs to the memory 101 via the PCI bus 94 and the PCI bridge 97 under the control of the stream transfer unit 162.

Upon completion of the transfer of the coded streams to the memory 101, in step S13, the stream transfer unit 162 sends a transfer completion report and GOP information to the stream input unit 171 of the CPU 99 via the north bridge 92, the PCI bus 94, the PCI bridge 97, and the control bus 98.

Upon receiving the transfer completion report, the stream input unit 171 sends an acknowledgement of the reception of the transfer completion report to the display command generator 163 of the CPU 91 via the control bus 98, the PCI bridge 97, the PCI bus 94, and the north bridge 92.

Upon receiving the acknowledgement from the stream input unit 171, in step S14, the display command generator 163 generates display commands and sends the display commands to the time manager 172 of the CPU 99 via the north bridge 92, the PCI bus 94, the PCI bridge 97, and the control bus 98.

The display command generator 163 generates a display command for each of the frames forming the first GOP of the coded stream A transferred to the memory 101 and also generates a display command for each of the frames forming the first GOP of the coded stream B transferred to the memory 101.

Upon receiving the display commands from the display command generator 163, the time manager 172 supplies the display commands to the execution controller 173 when the execution start times of the display commands have been reached. The execution controller 173 controls the execution of the decoding, composite processing, and reduction processing for the designated frames on the basis of the display commands supplied from the time manager 172. When the designated frames are supplied to the memory 101 after being subjected to the above-described processing, the execution controller 173 sends a processing completion report to the display controller 164 of the CPU 91 via the control bus 98, the PCI bridge 97, the PCI bus 94, and the north bridge 92. If an error occurs during the execution of the decoding, composite processing, or reduction processing on the specified frames, the execution controller 173 sends an error occurrence report to the display controller 164.

In step S15, the display controller 164 determines whether an error occurrence report has been received from the execution controller 173. If it is determined that an error occurrence report has been received, the display control processing is terminated since it is not possible to display images in the image areas 12 and 23.

If it is determined in step S15 that an error occurrence report has not been received, i.e., a processing completion report has been received, the process proceeds to step S16. In step S16, the display controller 164 displays images in the image areas 12 and 23. More specifically, the display controller 164 controls the north bridge 92 to obtain the video signal subjected to the reduction processing performed by the resizer 104 from the memory 101 via the PCI bus 94 and the PCI bridge 97 and to temporarily store the obtained video signal in the memory 93. The display controller 164 then controls the north bridge 92 to supply the video signal to a display device (not shown) and controls the display device to display the associated image.

In step S17, the display controller 164 identifies the completion of the display of frames for one GOP. That is, by monitoring which frame has been displayed, the display controller 164 can identify the completion of the display of frames for one GOP. Then, the display controller 164 sends a display completion report to the stream transfer unit 162.

In step S18, the stream transfer unit 162 determines whether the displayed GOP is the final GOP of the specified coded streams, i.e., whether all images of the specified coded streams have been displayed.

If it is determined in step S18 that the displayed GOP is the final GOP, it means that all the images have been displayed, and thus, the display control processing is completed.

If it is determined in step S18 that the displayed GOP is not the final GOP, the process proceeds to step S19 to determine whether there is any coded stream that has not been transferred. For example, among the GOPs including the frames forming the coded streams stored in the HDD 96, if there is any GOP that has not been transferred, the stream transfer unit 162 determines that there is a coded stream that has not been transferred.

If it is determined in step S19 that there is no coded stream that has not been transferred, it means that all the GOPs necessary for decoding have been transferred, the process proceeds to step S14.

In contrast, if it is determined in step S19 that there is a coded stream that has not been transferred, the process proceeds to step S20. In step S20, the stream transfer unit 162 controls the north bridge 92 to read out one GOP of the coded stream A and one GOP of the coded stream B from the HDD 96. The stream transfer unit 162 then sends a command to add the GOP ID to the corresponding coded stream to the stream input unit 171. Upon receiving the command from the stream transfer unit 162, the stream input unit 171 controls the north bridge 92 to add the GOP ID to the head of each GOP of the coded streams A and B.

In step S21, the stream transfer unit 162 controls the north bridge 92 to transfer the coded streams A and B to the memory 101.

Then, in step S22, the stream transfer unit 162 sends a transfer completion report and GOP information to the stream input unit 171 of the CPU 99 via the north bridge 92, the PCI bus 94, the PCI bridge 97, and the control bus 98. The process then proceeds to step S14.

As discussed above, the CPU 91 transfers coded streams to the memory 101 in units of GOPs, and also issues display commands to decode the coded streams. Then, the CPU 91 supplies the video signal as a result of performing decoding, composite processing, and reduction processing to a display device and displays the image on the display device.

After the CPU 91 transfers the coded streams to the memory 101 and sends the display commands to the CPU 99, the CPU 99 receives the display commands from the CPU 91, and performs execution control processing for controlling the execution of decoding, composite processing, and reduction processing.

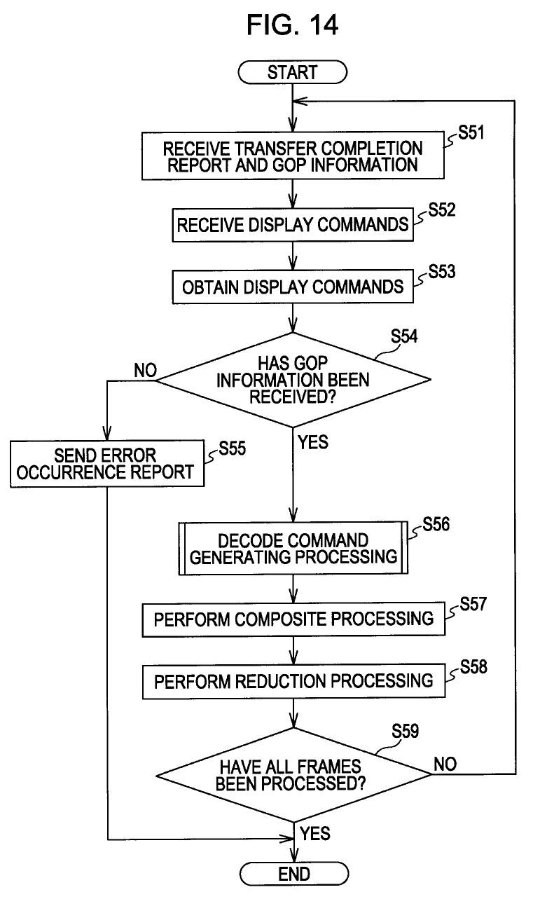

The execution control processing performed by the CPU 99 is described below with reference to the flowchart in FIG. 14.

In step S51, the stream input unit 171 receives a transfer completion report and GOP information from the stream transfer unit 162. That is, in response to a transfer completion report and GOP information from the stream transfer unit 162, the stream input unit 171 receives them.

The stream input unit 171 then sends an acknowledgement of the receipt of the transfer completion report to the display command generator 163. The stream input unit 171 then supplies the received GOP information to the decode command generator 181.

In step S52, the time manager 172 receives the display commands from the display command generator 163. For example, the time manager 172 receives the display commands for one GOP forming the coded stream A and the display commands for one GOP forming the coded stream B. The time manager 172 analyzes the display commands. The time manager 172 then refers to the start times indicated in the display commands to supply display commands that have reached the execution time to the decode command generator 181 of the execution controller 173.

In step S53, the decode command generator 181 obtains the display commands that have reached the execution time from the time manager 172. For example, the decode command generator 181 obtains the display command for a predetermined frame forming the coded stream A and the display command for a predetermined frame forming the coded stream B.

In step S54, the decode command generator 181 determines whether GOP information has been received. For example, if GOP information concerning the GOP containing the frame designated by the obtained display command has been supplied from the stream input unit 171, the decode command generator 181 determines that the GOP information has been received.

If it is determined in step S54 that GOP information has not been received, it means that it is difficult to decode the frame designated by the display command without GOP information, and thus, the process proceeds to step S55. In step S55, the execution controller 173 generates and sends an error occurrence report to the display controller 164 and then terminates the execution control processing.

In contrast, if it is determined in step S54 that GOP information has been received, the decode command generator 181 requests the stream input unit 171 to transfer the GOP containing the frame designated by the display command and the GOP including a reference frame necessary for decoding the subject frame to the decoder 102.

Then, in step S56, the CPU 99 performs decode command generating processing. In the decode command generating processing, the CPU 99 generates decode commands for decoding coded streams and supplies the generated decode commands to the decoder 102. Details of the decode command generating processing are discussed below.

In response to the supply of the decode commands to the decoder 102 from the decode command generator 181, the decoder 102 decodes the frames specified by the decode commands and supplies the resulting non-compressed video signals to the memory 101 and stores them therein. Upon completion of the decoding of the frames specified by the decode commands, the decode controller 221 of the decoder 102 supplies a decode completion report to the execution controller 173.

After the video signals are stored in the memory 101 and the decode completion report has been supplied to the execution controller 173 from the decode controller 221, in step S57, the execution controller 173 controls the compositor 103 to perform composite processing on the video signals obtained by decoding the coded streams A and B and stored in the memory 101. Under the control of the execution controller 173, the compositor 103 obtains the video signals from the memory 101 and performs composite processing on the obtained video signals. The compositor 103 then supplies the resulting video signal to the memory 101 and stores it therein.

In step S58, the execution controller 173 controls the resizer 104 to perform reduction processing on the video signal subjected to the composite processing and stored in the memory 101. Under the control of the execution controller 173, the resizer 104 obtains the video signal from the memory 101 and performs reduction processing. For example, the resizer 104 performs reduction processing on the video signal so that the size of the image represented by the video signal is converted from a high definition (HD) image to a standard definition (SD) image. The resizer 104 then supplies the video signal subjected to the reduction processing to the memory 101 and stores it therein.

In step S59, the time manager 172 determines whether all the frames have been processed, i.e., whether all the display commands have been executed.

If it is determined in step S59 that not all the frames have been processed, the process returns to step S51.

In contrast, if it is determined that all the frames have been processed, the execution control processing is completed.

As described above, the CPU 99 receives display commands from the CPU 91 and executes processing specified by the display commands.

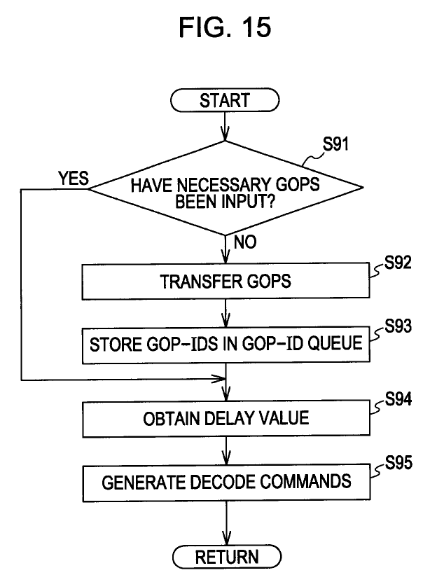

Details of the decode command generating processing in step S56 in FIG. 14 are discussed below with reference to the flowchart in FIG. 15.

In step S91, the stream input unit 171 determines whether GOPs necessary for decoding frames have been input into the decoder 102. That is, the stream input unit 171 determines in step S91 whether GOPs that have been transferred in response to a request from the decode command generator 181, i.e., the GOP containing the frame to be decoded and GOPs containing reference frames necessary for decoding the subject frame, have been input into the decoder 102.

For example, the stream input unit 171 manages GOPs input into the decoder 102 by utilizing a GOP ID queue. In the GOP ID queue, the GOP IDs of GOPs temporarily stored in the decoder 102 are arranged in the order in which the GOPs have been input into the decoder 102.

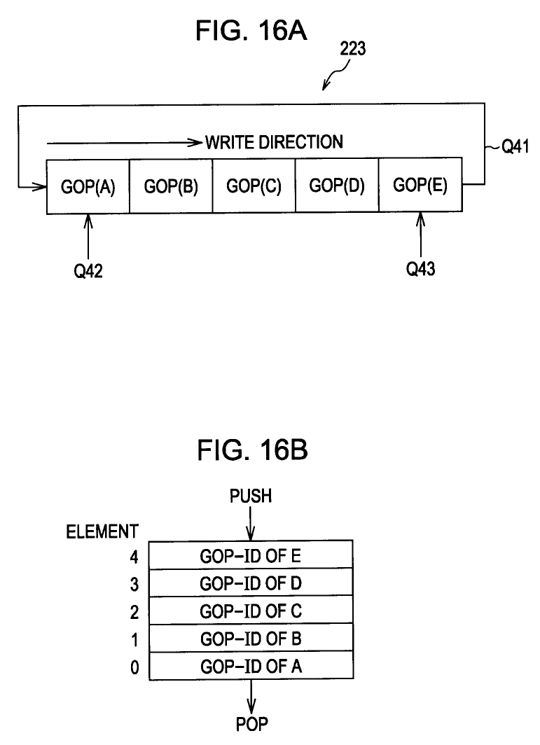

For example, in the stream buffer 223 of the decoder 102, as shown in FIG. 16A, a maximum of five GOPs can be buffered. In the example shown in FIG. 16A, in the stream buffer 223, a GOP(A), a GOP(B), a GOP(C), a GOP(D), and a GOP(E) are sequentially buffered in that order.

The GOPs are sequentially written into the stream buffer 223, as indicated by the arrow Q41, in the rightward direction from the area in which the GOP(A) is stored. When a new GOP is written into the area in which the GOP(E) is stored, the GOP stored in the GOP(E) is returned to the area at the head of the stream buffer 223, and more specifically, to the area in which the GOP(A) is stored.

In FIG. 16A, the arrow Q42 and the arrow Q43 indicate the position of the area in which the oldest GOP is stored and the position of the area in which the latest GOP is stored, respectively. Accordingly, every time a new GOP is written into the stream buffer 223, the arrows Q42 and Q43 are shifted one by one in the direction indicated by the arrow Q41.

In this manner, when a maximum of five GOPs are buffered in the stream buffer 223, the GOP ID queue, such as that shown in FIG. 16B, is stored in the stream input unit 171. In the GOP ID queue, five elements from the number 0 to the number 4 are stored (queued). That is, the elements from the number 0 to the number 4 represent the GOP IDs of the GOP(A) through the GOP(E), respectively, shown in FIG. 16A.

The GOP IDs stored in the GOP ID queue, which are each 32-bit identifiers for specifying the GOPs, are the GOP IDs contained in the GOP information. The GOP IDs are stored in the order from the number 0 to the number 4, i.e., in the order in which the GOPs have been transferred to the stream buffer 223. That is, the GOP ID stored as the element of number 0 is the GOP ID of the GOP(A) written into the stream buffer 223 temporally for the first time, and the GOP ID stored as the element of number 4 is the GOP ID of the GOP(E) written into the stream buffer 223 most recently.

Every time a new GOP is transferred to the stream buffer 223, the stream input unit 171 allows the GOP ID of the new GOP transferred as the element of number 4 to push into the GOP ID queue and allows the GOP ID stored as the element of number 0 to pop out of the GOP ID queue.

In this manner, the GOP IDs of GOPs stored in the stream buffer 223 are stored in the stream input unit 171 in the order in which the GOPs have been transferred. This enables the stream input unit 171 to identify which GOP is stored in the stream buffer 223. This eliminates the need for the stream input unit 171 to transfer a GOP to the stream buffer 223 every time a decode command is issued in the decode command generator 181.

Although in the above-described example the maximum number of GOPs to be buffered in the stream buffer 223 is five, it may be four or smaller or six or greater.

The stream input unit 171 stores such a GOP ID queue for each of the decoders 102-1 and 102-2.

Accordingly, if the GOP IDs of the GOPs that should be transferred in response to a request from the decode command generator 181 are stored in the GOP ID queue, the stream input unit 171 determines in step S91 that the GOPs necessary for decoding frames have been input into the decoder 102.

Referring back to the description of the flowchart in FIG. 15, if it is determined in step S91 that GOPs necessary for decoding frames have been input, the process proceeds to step S94 by skipping steps S92 and S93 since it is not necessary to transfer GOPs to the stream buffer 223.

In contrast, if it is determined in step S91 that GOPs necessary for decoding frames have not been input, the process proceeds to step S92. In step S92, the stream input unit 171 controls the memory 101 to transfer, among the GOPs requested from the decode command generator 181, the GOPs that have not been transferred to the stream buffer 223 one by one.

That is, the stream input unit 171 controls the memory 101 to supply, among the GOPs stored in the memory 101, the GOPs specified by the GOP IDs that have not been transferred to the stream buffer 223.

In step S93, the stream input unit 171 stores the GOP IDs of the GOPs in the GOP ID queue in the order in which the GOPs have been transferred to the stream buffer 223 from the memory 101.

After step S93 in which the GOP IDs of the transferred GOPs are stored in the GOP ID queue or if it is determined in step S91 that the GOPs necessary for decoding frames have been input, the process proceeds to step S94. In step S94, the decode command generator 181 obtains the delay value from the delay table of the delay table storage unit 174 on the basis of the bit rate ID contained in the display commands supplied from the time manager 172.

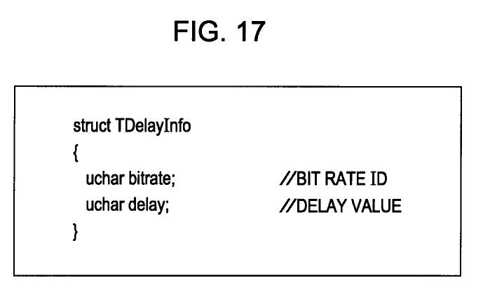

For example, the delay table storage unit 174 stores, as shown in FIG. 17, a delay table in which a delay value is stored for each bit rate ID, and more specifically, a delay value is provided for a bit rate, represented by the bit rate ID, of a coded stream to be decoded.

Although information concerning the delay value for only one bit rate ID is shown in FIG. 17, the delay table includes a plurality of items of information concerning the delay values for the bit rate IDs. The delay value is an integral multiple of the length of the display cycle in which frames are displayed, e.g., if the display cycle is T, the delay value is one of 2T, 3T, and 4T.

The decode command generator 181 obtains the delay value for the bit rate ID indicated in the display commands as the delay value representing the delay time provided for the frames to be decoded by referring to the delay table stored in the delay table storage unit 174. It is now assumed that the bit rates of the coded streams A and B are the same, and thus, the decode command generator 181 obtains the same delay value for the display commands for the coded streams A and B.

Referring back to the description of the flowchart in FIG. 15, in step S95, the decode command generator 181 generates decode commands for allowing the decoder 102 to perform decoding on the basis of the display commands, the obtained delay values, and the GOP information supplied from the stream input unit 171.

For example, the decode command generator 181 generates decode commands for frames forming the coded stream A and decode commands for frames forming the coded stream B so that the frame IDs of the frames, the GOP IDs of the GOPs containing the frames, the delay value, and information concerning reference frames necessary for decoding the frames, i.e., the frame IDs of the reference frames, can be contained in the decode commands. In this case, the frame IDs and the GOP IDs contained in the decode commands are the same as those in the display commands.

After generating the decode commands, the decode command generator 181 supplies the generated decode commands to the decode controller 221 of the decoder 102, and the process proceeds to step S57 in FIG. 14. In response to the decode commands supplied from the decode command generator 181, the decoder 102 decodes the frames specified by the decode commands, and supplies the resulting video signals to the memory 101 and stores them therein. Upon completion of the decoding of the frames specified by the decode commands, the decode controller 221 of the decoder 102 supplies a decode completion report to the execution controller 173.

More specifically, the decode command generator 181 refers to the GOP ID queue stored in the stream input unit 171, and if the frame specified by the display command is the frame contained in the GOP specified by the GOP ID stored first among the GOP IDs stored in the GOP ID queue, the decode command generator 181 does not generate a decode command. The execution controller 173 then sends an error occurrence report to the display controller 164.

For example, in the GOP ID queue shown in FIG. 16B, the GOP(A), which is the element of number 0 stored first, is the oldest GOP input into the stream buffer 223 among the GOPs buffered in the stream buffer 223.

If a decode command is issued for a frame contained in the GOP(A), the following situation is encountered. If a new GOP is input into the stream buffer 223, the GOP(A) stored in the stream buffer 223 is overwritten by the new GOP. Thus, even if an instruction to decode a frame contained in the GOP(A) is given, the decoder 102 is unable to decode the frame since the GOP(A) is not stored in the stream buffer 223.

Thus, in order to prevent such a situation, the decode command generator 181 does not issue a decode command for a frame contained in the GOP specified by the oldest GOP ID stored in the GOP ID queue.

The decode command generator 181 issues decode commands for frames contained in the GOPs specified by the GOP IDs, which are the elements of number 1 to number 4, stored in the GOP ID queue. The stream input unit 171 can identify which GOP is buffered in the stream buffer 223 by referring to the GOP ID queue. This eliminates the need for the stream input unit 171 to transfer a GOP to the stream buffer 223 every time a decode command is issued for a frame contained in the GOP specified by the GOP ID of one of the elements from number 0 to number 4.

As described above, the CPU 99 transfers a coded stream in units of GOPs to the stream buffer 223, and generates decode commands containing a delay value based on the bit rate of the coded stream.

In this manner, by transferring a coded stream in units of GOPs to the stream buffer 223 and by generating decode commands containing a delay value based on the bit rate of the coded stream, the processing latency of the coded stream A and that of the coded stream B can become the same duration regardless of the transfer time of the GOPs or the picture types and the positions of the frames in the GOPs.

That is, by issuing decode commands containing a delay value and by delaying the start of decoding by an amount equal to the delay time represented by the delay value, the time at which the decoding of the frames forming the coded stream A is finished can be synchronized with the time at which the decoding of the frames forming the coded stream B is finished. This enables the display of a plurality of images to be synchronized with each other more easily.

Additionally, the decoding of the frame of the coded stream A and that of the coded stream B to be displayed at the same time can be finished simultaneously. This eliminates the need for reserving a storage capacity storing video signals for a plurality of frames in the memory 101 in order to absorb a difference in the processing latency. As a result, the size of the editing apparatus 81 can be reduced.

After the decode command generating processing, decode commands are issued and are supplied from the decode command generator 181 to the decode controller 221 of the decoder 102. Then, the decoder 102 starts decoding frames specified by the decode commands.

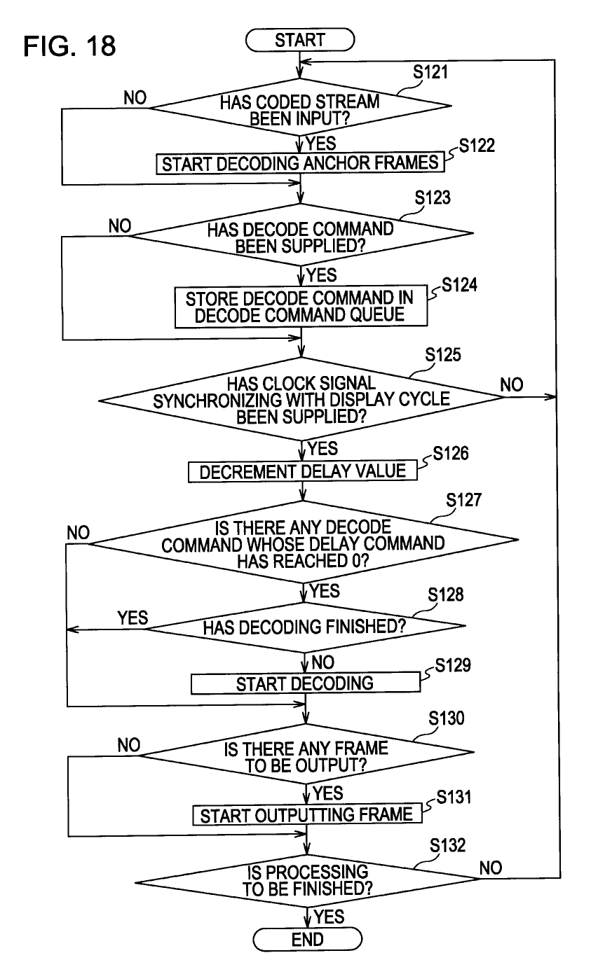

The decode processing performed by the decoder 102 is described below with reference to the flowchart in FIG. 18. This decode processing is executed in each of the decoders 102-1 and 102-2.

In step S121, the decode controller 221 determines whether a new coded stream has been input into the stream buffer 223. If it is determined in step S121 that a new coded stream has not been input, the process proceeds to step S123.

If it is determined in step S121 that a new coded stream has been input, the process proceeds to step S122. In step S122, the decode controller 221 controls the decode processor 224 to start decoding anchor frames.

More specifically, the decode controller 221 controls the stream buffer 223 to supply anchor frames contained in the input coded stream to the decode processor 224 on a frame-by-frame basis. The decode controller 221 then controls the decode processor 224 to decode the anchor frames supplied to the decode processor 224 from the stream buffer 223 by a predetermined method, such as an MPEG method, and to supply the resulting non-compressed video signals to the predetermined reference bank 231. The decode controller 221 controls the selector 226, if necessary, to supply the reference frames for the anchor frames to be decoded by the decode processor 224, to the decode processor 224 from the reference bank 231.

If it is difficult to immediately decode an anchor frame since another frame is being decoded in the decode processor 224 or another anchor frame is stored in the reference bank 231, the decode controller 221 controls the decode processor 224 to start decoding when the decoding of the anchor frames of a new coded stream is ready to be started.

After step S122 in which the decoding of the anchor frames is started, or if it is determined in step S121 that a new coded stream has not been input, the process proceeds to step S123. In step S123, the decode controller 221 determines whether a decode command has been supplied from the decode command generator 181. If it is determined in step S123 that a decode command has not been supplied, the process proceeds to step S125.

If it is determined in step S123 that a decode command has been supplied, the process proceeds to step S124. In step S124, the decode controller 221 stores the decode command supplied from the decode command generator 181 in the decode command queue in the order in which the decode commands have been supplied.

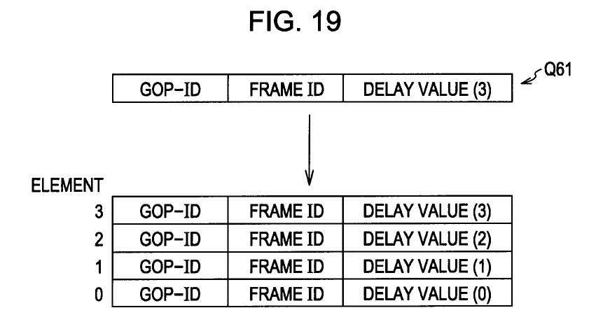

For example, the decode command indicated by the arrow Q61 shown in FIG. 19 is supplied to the decode controller 221 from the decode command generator 181. In the example shown in FIG. 19, the decode command includes the GOP ID of the GOP containing the subject frame, the frame ID, and the delay value. In the delay value, the number in the parenthesis indicates the number of display cycles representing the delay time by which the start of the decoding is delayed. The number of display cycles represented by the delay value of the decode command indicated by the arrow Q61 is 3, which means that the delay time is three times as long as the display cycle T, i.e., 3T. Accordingly, this decode command having the delay value 3 is executed after three display cycles after it has been stored in the decode command queue.

In the decode command queue, four elements from number 0 to number 4 are stored (queued), and the decode commands are stored in the order in which they have been supplied to the decode controller 221, i.e., in the order of number 0 to number 3. That is, the decode command stored as the element of number 0 is the decode command stored first, and the decode command stored as the element of number 3 is the decode command stored most recently.

Upon receiving a decode command from the decode command generator 181, the decode controller 221 allows the decode command to push into the decode command queue. When the time at which a frame is displayed in the editing apparatus 81 has been reached, i.e., the time at which the display command is executed has been reached, the decode controller 221 decrements the delay value of each decode command stored in the decode command queue one by one. Then, the decode controller 221 executes the decode command whose delay value has become 0, and makes available the element of the executed decode command. In the example shown in FIG. 19, since the delay value of the decode command stored as the element of number 0 is 0, the decode controller 221 executes this decode command, and makes available the element of the decode command.

Referring back to the description of the flowchart in FIG. 18, after step S124 in which the decode command is stored in the decode command queue, or if it is determined in step S123 that a decode command has not been supplied, the process proceeds to step S125. In step S125, the decode controller 221 determines whether a clock signal synchronizing with the display cycle has been supplied from the clock signal generator 222.

The reason for executing step S125 is as follows. The CPU 91 and the CPU 99 execute various operations or control the operations performed by the elements forming the editing apparatus 81 on the basis of a clock signal having a display cycle T. In contrast, the clock signal generator 222 provided for the decoder 102 generates a clock signal having a cycle one-fourth the display cycle, and the decode controller 221 controls various operations performed by the elements forming the decoder 102 on the basis of the clock signal generated by the clock signal generator 222.

Accordingly, in every four clocks, a clock signal generated by the clock signal generator 222 is synchronized with the time at which the CPU 91 or the CPU 99 executes processing. When the clock signal supplied from the clock signal generator 222 is synchronized with the time at which the CPU 91 or the CPU 99 executes processing, the decode controller 221 determines in step S125 that a clock signal synchronizing with the display cycle has been supplied.

If it is determined in step S125 that a clock signal synchronizing with the display cycle has not been supplied, the process returns to step S121.

If it is determined in step S125 that a clock signal synchronizing with the display cycle has been supplied, i.e., after the lapse of one display cycle after the time at which the previous frame has been displayed, the process proceeds to step S126. In step S126, the decode controller 221 decrements the delay value of each decode command stored in the decode command queue by one. For example, since the delay value of the decode command stored as the element of number 1 shown in FIG. 19 is 1, the decode controller 221 decrements the delay value by one to 0.

Also, in FIG. 12, for example, if a decode command having the delay value 3 is supplied to the decode controller 221 from the decode command generator 181 at time t42, the decode controller 221 decrements the delay value by one to 2 at time t43, and by one to 1 at time t45, and by one to 0 at time t46. Then, the decode controller 221 obtains the decode command from the decode command queue to start decoding the decode command.

In this manner, every time a clock signal synchronizing with the display cycle is supplied, i.e., every time the time at which a frame is displayed has been reached, the decode controller 221 decrements the delay value of each decode command stored in the decode command queue by every duration of the display cycle, i.e., one, to count the time before the decoding of the frame specified by each decode command is started.

In step S127, the decode controller 221 determines whether there is any decode command whose delay value has reached 0. If it is determined in step S127 that there is no decode command whose delay value has reached 0, it means that there is no decode command to be executed, and thus, the process proceeds to step S130 by skipping steps S128 and S129.

In contrast, if it is determined in step S127 that there is a decode command whose delay value has reached 0, the decode controller 221 obtains that decode command, and makes available the element in which the decode command is stored.

Then, in step S128, the decode controller 221 determines whether the decoding of the frame designated by the obtained decode command has finished. For example, if the frame designated by the decode command is an anchor frame, the anchor frame is decoded immediately after it is input into the decoder 102. Accordingly, at the time when the decode command is executed, the decoding of the frame has already finished and is stored in the frame memory 225. If the decoding of the frame designated by the decode command has finished and is stored in the frame memory 225, the decode controller 221 determines in step S128 that the decoding of the frame has finished.

If it is determined in step S128 that the decoding has finished, it means that the decoding of the frame is not conducted any more, and the process proceeds to step S130.

If it is determined in step S128 that the decoding has not finished, the process proceeds to step S129. In step S129, the decode controller 221 controls the decode processor 224 to start decoding the frame designated by the decode command.

That is, the decode controller 221 controls the stream buffer 223 to supply the frame designated by the decode command, and more specifically, data for displaying the specified frame of the coded stream, to the decode processor 224. Then, the decode controller 221 controls the decode processor 224 to decode the frame supplied to the decode processor 224 from the stream buffer 223 and to supply the resulting non-compressed video signal to the predetermined display dedicated bank 232 and store it therein. The decode controller 221 also controls the selector 226 to supply the reference frame for the subject frame to be decoded by the decode processor 224 to the decode processor 224 from the reference bank 231.

Under the control of the decode controller 221, the decode processor 224 decodes the frame, i.e., the frame data, supplied from the stream buffer 223 by using the reference frame supplied from the selector 226, and supplies the resulting video signal to the display dedicated bank 232 of the frame memory 225 and stores it therein. Upon completion of the decoding of the frame designated by the decode command, the decode controller 221 supplies a decode completion report to the execution controller 173 of the CPU 99.

After step S129 in which the decoding is started, or if it is determined in step S128 that the decoding has finished, or if it is determined in step S127 that there is no decode command whose delay value has reached 0, the process proceeds to step S130. In step S130, the decode controller 221 determines whether there is any frame that has reached the output time.

For example, the decode controller 221 determines that a frame that has reached the decoding time when the previous clock signal synchronizing with the display cycle has been supplied from the clock signal generator 222 and that is stored in the reference bank 231 or the display dedicated bank 232 when the current clock signal synchronizing with the display cycle is supplied from the clock signal generator 222 is the frame that has reached the output time. In this case, the decode controller 221 determines that there is a frame that has reached the output time.

If it is determined in step S130 that there is no frame that has reached the output time, the process proceeds to step S132 by skipping step S131. In contrast, if it is determined in step S130 that there is a frame that has reached the output time, the process proceeds to step S131. In step S131, under the control of the decode controller 221, the output unit 227 obtains the frame that has reached the output time from the reference bank 231 or the display dedicated bank 232 and outputs the obtained frame to the memory 101. The memory 101 then stores a video frame corresponding to the frame supplied from the output unit 227.

After step S131 in which the frame is output or if it is determined in step S130 that there is no frame to be output, the process proceeds to step S132. In step S132, the decode controller 221 determines whether the processing is to be finished. If, for example, no decode command is stored in the decode command queue, the decode controller 221 determines that the processing is to be finished.

If it is determined in step S132 that the processing is not finished, i.e., that there is a decode command stored in the decode command queue, the process returns to step S121.

In contrast, if it is determined in step S132 that the processing is to be finished, the decode processing is completed.

As described above, upon receiving a decode command from the decode command generator 181, the decoder 102 delays starting to decode the frame by an amount equal to the delay value indicated in the decode command, and then executes the decode command to start decoding.

In this manner, by delaying starting to decode a frame by an amount equal to the delay value contained in a decode command and by then executing the decode command to start decoding the frame, the frame can be output after the lapse of a predetermined time after receiving the decode command regardless of the picture type and the position of the frame in the GOP. Accordingly, the time at which the decoding of the frame forming the coded stream A is finished can be synchronized with the time at which the decoding of the frame forming the coded stream B is finished. This enables the display of a plurality of images to be synchronized with each other more easily.

In the above-described example, the bit rates of a plurality of coded streams to be edited are the same. If the bit rates of a plurality of coded streams are different, the processing latencies of the coded streams also become different.

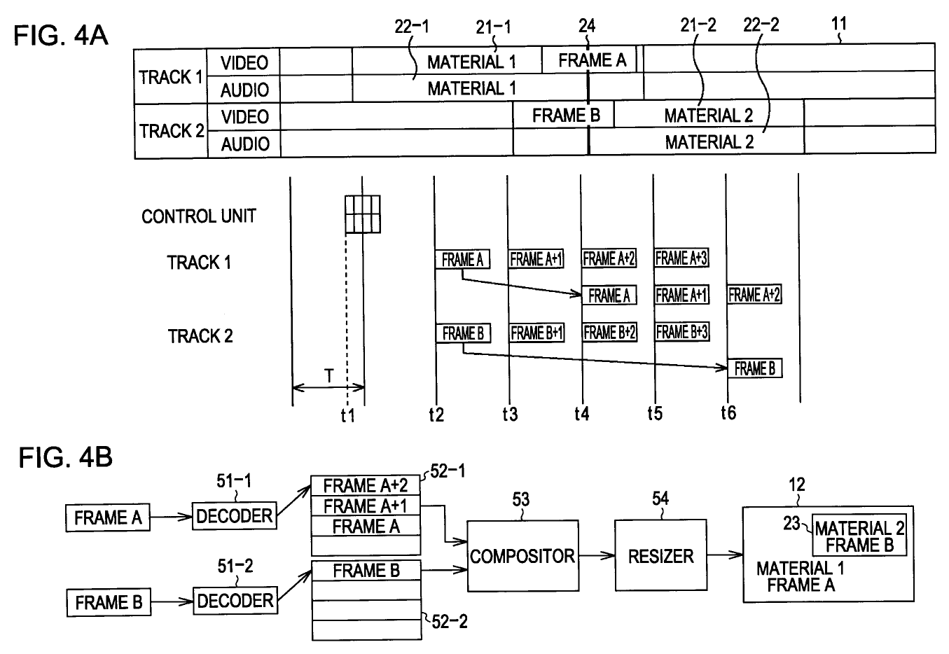

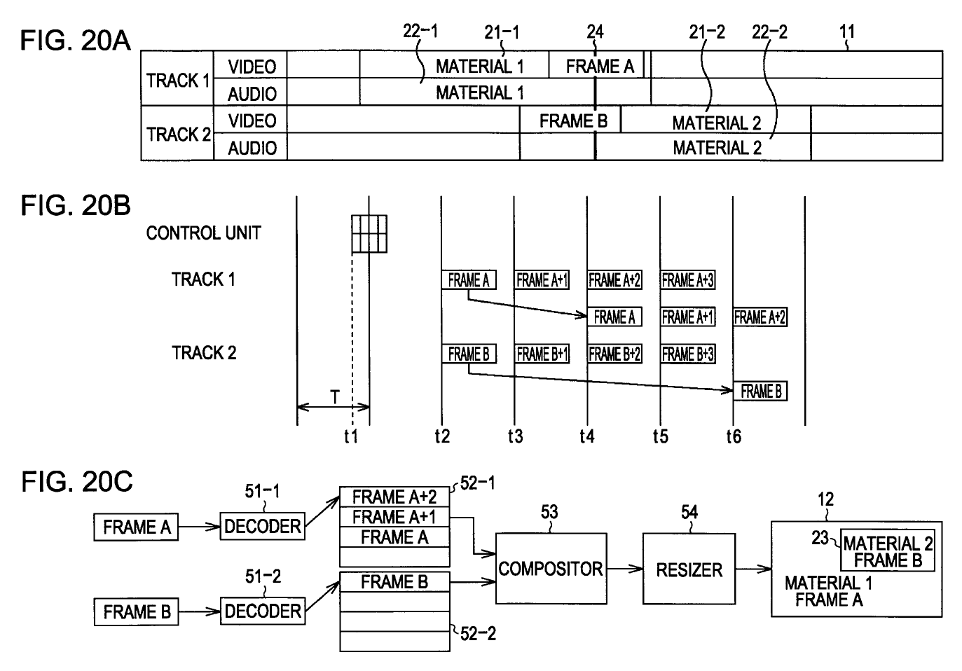

For example, in the material 1 and the material 2 shown in FIG. 20A, if the bit rate of the video data 21-2 of the material 2 is higher than the bit rate of the video data 21-1 of the material 1, the processing latency of the material 2 becomes longer than that of the material 1. That is, the input time for inputting the coded stream of the material 2 into the decoder and the decoding time are longer than those of the coded stream of the material 1 since the bit rate of the material 2 is higher than that of the material 1. In FIGS. 20A through 20C, elements corresponding to those in FIGS. 4A and 4B are designated with like reference numerals, and an explanation thereof is thus omitted.

In FIG. 20A, the cursor 24 is positioned at the frame A of the video data 21-1 and the frame B of the video data 21-2. Accordingly, at time t1, the control unit that executes an editing application program issues, as shown in FIG. 20B, on a frame-by-frame basis, commands to display the frame A through the frame A+3 and commands to display the frame B through the frame B+3 to the processor.

Upon receiving a command from the control unit, at time t2, the processor controls the decoder to start decoding the frame A of the material 1 and the frame B of the material 2. Then, in the example shown in FIG. 20B, the decoding of the frame A is finished at time t4. On the other hand, even though the decoding of the frame B is started at the same time with the frame A, the decoding of the frame B is not finished until time t6 since the bit rate of the material 2 is higher than that of the material 1.

The processing latency of the material 1 is 2 display cycles, while the processing latency of the material 2 is 4 display cycles. To provide synchronization of the display of the frame A and the frame B, as shown in FIG. 20C, the frame buffer 52-1 needs a storage capacity for storing three frames of video data. Additionally, control should be performed so that the frame A and the frame B are simultaneously supplied to the compositor 53.

In this manner, if the bit rates of a plurality of coded streams to be edited are different, in the editing apparatus 81 shown in FIG. 5, the CPU 91 can perform control so that the processing latency of the coded stream A and that of the coded stream B can become the same duration since the CPU 91 identifies the bit rates of the coded streams A and B.

That is, on the basis of the information supplied from the operation input receiver 161, the display command generator 163 issues display commands for the coded streams A and B so that, between the two bit rate IDs of the coded streams A and B, the bit rate ID having the higher bit rate is contained in the display commands.

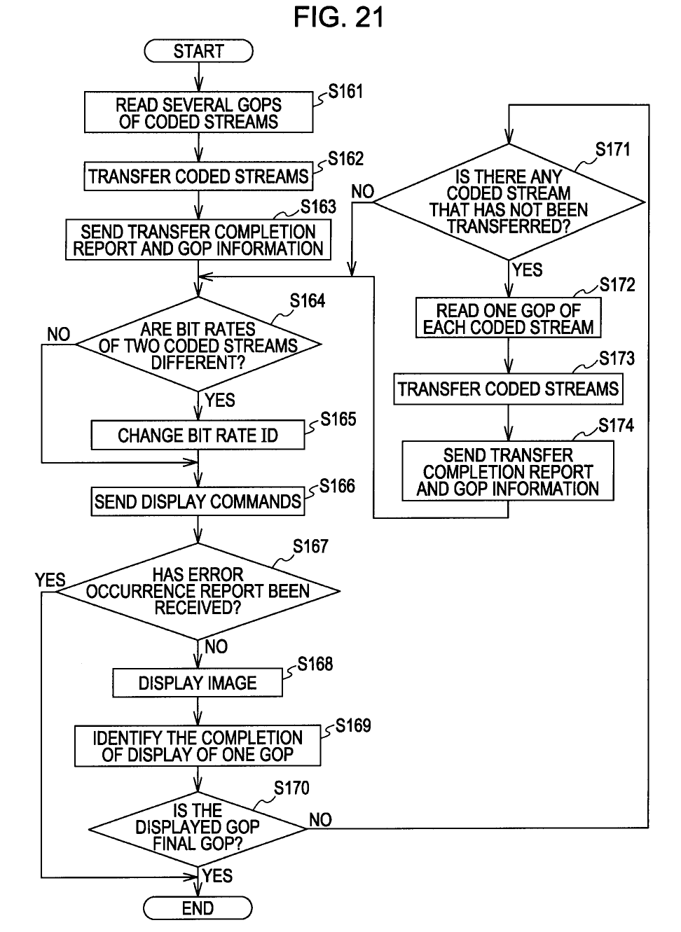

A description is now given, with reference to the flowchart in FIG. 21, of display control processing when the bit rates of the coded streams A and B are different. Steps S161 through S163 are similar to steps S11 through S13, respectively, in FIG. 13, and an explanation thereof is thus omitted.

In step S164, the display command generator 163 determines on the basis of the bit rate IDs supplied from the operation input receiver 161 whether the bit rates of the coded stream A and the coded stream B to be edited are different.

If the bit rates are found to be the same in step S164, it is not necessary to change the bit rate IDs, and the process proceeds to step S166 by skipping step S165.

In contrast, if the bit rates are found to be different in step S164, the process proceeds to step S165. In step S165, the display command generator 163 changes the bit rate ID of the lower bit rate to the bit rate ID of the higher bit rate.

For example, if the bit rate of the coded stream A is lower than that of the coded stream B, the display command generator 163 changes the bit rate ID of the coded stream A to that of the coded stream B.

After step S165 in which the bit rate ID is changed, if it is determined in step S164 that the bit rates are the same, the process proceeds to step S166. In step S166, the display command generator 163 generates a display command containing the bit rate ID changed in accordance with the necessity and sends the generated display command to the time manager 172 of the CPU 99.

Steps S167 through S174 are similar to steps S15 through S22, respectively, in FIG. 13, and an explanation thereof is thus omitted.

Upon receiving a display command containing the bit rate ID changed in accordance with the necessity, the CPU 99 performs processing, assuming that the bit rate of the frame designated by the display command is the bit rate represented by the bit rate ID, and thus provides the same delay value for the coded streams A and B.

That is, the bit rate ID of each coded stream is changed to the higher bit rate of the two bit rates. Accordingly, the delay value provided for each coded stream is set to be the delay value necessary for starting the subject frame of the coded stream that exhibits a higher bit rate, i.e., that needs a longer pre-processing time.

It is thus possible to finish decoding the frames of the coded streams A and B in time for the output time scheduled by the CPU 99, and also, the processing latency of the coded stream A and that of the coded stream B before the completion of decoding can become the same duration.

As described above, by changing the bit rate ID according to the necessity, it is possible to control the processing latency of the coded stream A and that of the coded stream B to be the same duration. This enables the display of a plurality of images to be synchronized with each other more easily.

Although in the above-described example the CPU 91 changes the bit rate ID, the decode command generator 181 may change the bit rate ID. In this case, by using the bit rate ID contained in a display command of the coded stream A and the bit rate ID contained in a display command of the coded stream B obtained from the time manager 172, the decode command generator 181 compares the bit rates of the two bit rate IDs and changes the bit rate ID of the coded stream having the lower bit rate into the bit rate ID of the coded stream having the higher bit rate. Then, the decode command generator 181 generates a decode command.

Although in the above-described example the number of coded streams to be edited is two, three or more coded streams may be edited.

In the above-described embodiment, the CPU 91 and the CPU 99 perform processing in a distributed manner by sending and receiving signals. However, processing may be performed by the use of a single CPU, i.e., the CPU 91 or the CPU 99. In this case, the processing indicated by the flowchart in FIG. 14 may be performed by the CPU 91.

Additionally, in the above-described embodiment, the MPEG method is used as the decoding method. However, another decoding method accompanying frame correlation, for example, advanced video coding (AVC)/H.264, may be used to implement the present invention.

The above-described series of processing operations may be executed by hardware or software. If software is used, a corresponding software program is installed from a program recording medium into a computer built in dedicated hardware or a computer, such as a general-purpose computer, which can execute various functions by installing various programs thereinto.

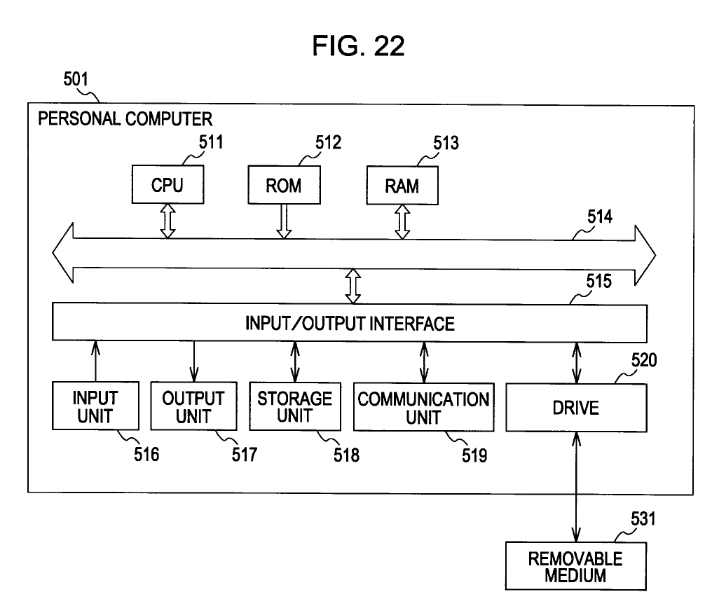

FIG. 22 is a block diagram illustrating an example of the configuration of a personal computer 501 that executes the above-described series of processing operations by using the software program. In the personal computer 501, a CPU 511 executes various processing operations in accordance with a program stored in a read only memory (ROM) 512 or a storage unit 518. In a random access memory (RAM) 513, the programs and data executed by the CPU 511 are stored. The CPU 511, the ROM 512, and the RAM 513 are connected to each other with a bus 514 therebetween.

An input/output interface 515 is also connected to the CPU 511 with the bus 514 therebetween. An input unit 516 including a keyboard, a mouse, and a microphone, and an output unit 517 including a display and a speaker are connected to the input/output interface 515. The CPU 511 executes various processing operations in response to instructions input through the input unit 516. The CPU 511 outputs processing results to the output unit 517.

The storage unit 518, which is connected to the input/output interface 515, includes, for example, a hard disk, and stores programs and data executed by the CPU 511. A communication unit 519 communicates with an external device via a network, such as the Internet or a local area network (LAN).

The program may be obtained through the communication unit 519 and stored in the storage unit 518.

A drive 520 connected to the input/output interface 515 drives a removable medium 531, such as a magnetic disk, an optical disc, a magneto-optical disk, or a semiconductor memory, and reads a program or data stored in the installed removable medium 531. The read program or data is transferred to the storage unit 518 and stored therein if necessary.

The program recording medium storing a program to be installed into the computer and executed by the computer may be formed of the removable medium 531, as shown in FIG. 22, which is a package medium including a magnetic disk (including a flexible disk), an optical disc (including a compact disc read only memory (CD-ROM), a digital versatile disc (DVD), and a magneto-optical disk), the ROM 512 in which the program is temporarily or permanently stored, or a hard disk forming the storage unit 518. The storage of the program into the program recording medium may be performed via the communication unit 519, which is an interface, such as a router or a modem, or using a wired or wireless communication medium, such as a LAN, the Internet, or digital satellite broadcasting.

In this specification, steps forming the programs stored in the program recording medium may include processing executed in a time-series manner in the order described in the specification. They may also include processing executed in parallel and individually.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus that decodes a plurality of coded streams, comprising:
decoding means for decoding the plurality of coded streams; and
control means for controlling the decoding of the plurality of coded streams so that the start of decoding a subject frame among frames forming the plurality of coded streams is delayed by an amount equal to a delay time, which is the longest pre-processing time among pre-processing times necessary for starting decoding the frames after an instruction to decode the subject frame is given.

2. The information processing apparatus according to claim 1, further comprising storage means for storing video signals obtained as a result of performing decoding by the decoding means.

3. The information processing apparatus according to claim 1, wherein the control means delays the start of decoding the subject frame by an amount equal to the delay time which is determined by a bit rate of the plurality of coded streams.

4. The information processing apparatus according to claim 3, wherein the decoding means includes a first decoder that decodes a first coded stream and a second decoder that decodes a second coded stream, and
the control means delays the start of decoding a subject frame among frames forming the first coded stream and the second coded stream by an amount equal to the delay time which is determined by a higher bit rate of bit rates of the first coded stream and the second coded stream.

5. The information processing apparatus according to claim 1, wherein the plurality of coded streams are streams in conformity with MPEG standards, and
the delay time is determined on the basis of a time necessary for inputting the plurality of coded streams into the decoding means and a time necessary for decoding another frame which is decoded before the subject frame.

6. The information processing apparatus according to claim 1, wherein the delay time is an integral multiple of a length of a display cycle of the frames forming the plurality of coded streams, and
the decoding means counts a time before the decoding of the subject frame is started by decrementing the delay value by every duration equal to the length of the display cycle on the basis of a clock signal synchronizing with the display cycle.

7. An information processing method for decoding a plurality of coded streams, comprising the steps of:
controlling the decoding of the plurality of coded streams so that the start of decoding a subject frame among frames forming the plurality of coded streams is delayed by an amount equal to a delay time, which is the longest pre-processing time among pre-processing times necessary for starting decoding the frames after an instruction to decode the subject frame is given; and
decoding the plurality of coded streams.

8. An information processing apparatus that decodes a plurality of coded streams, comprising:
a decoder configured to decode the plurality of coded streams; and
a control unit configured to control the decoding of the plurality of coded streams so that the start of decoding a subject frame among frames forming the plurality of coded streams is delayed by an amount equal to a delay time, which is the longest pre-processing time among pre-processing times necessary for starting decoding the frames after an instruction to decode the subject frame is given.
